(19) United States
(12) Patent Application Publication
(10) Pub. No.: US 2021/0297280 A1
(43) Pub. Date: Sep. 23, 2021

(54) HOME APPLIANCE AND ONLINE SYSTEM THAT PERFORMS PAIRING OF THE SAME

(71) Applicant: LG ELECTRONICS INC., Seoul (KR)

(72) Inventors: Hyeonjun JEONG, Seoul (KR); Baekeun KWON, Seoul (KR)

(21) Appl. No.: 17/264,611

(22) PCT Filed: Jul. 31, 2019
(86) PCT No.: PCT/KR2019/009554

§ 371 Date: Jan. 29, 2021

(30) Foreign Application Priority Data
Jul. 31, 2018 (KR) 10-2018-0089386

(51) Int. Cl. H04L 12/28; H04W 4/80; G06K 9/00; H04W 76/30; H04W 76/14

(52) U.S. Cl. CPC H04L 12/2818; H04W 4/80; H04L 12/2809; G06K 9/00624; H04L 2012/285; H04W 76/14; G06K 2209/03; H04L 2012/2841; H04W 76/30

(57) ABSTRACT

The present invention relates to an online system capable of pairing a first home appliance and a second home appliance. The first home appliance and second home appliances may be directly paired, or the pairing can be established through an external terminal or a server. The first appliance and the second appliance may interlock with each other to set a course or an option.

### TECHNICAL FIELD

Embodiments of the present disclosure relate to a home appliance and an online system having the same, more particularly, to a setting method for pairing a plurality of home appliances that can recognize each other to transceive a signal and a method for using the pairing.

### BACKGROUND ART

Generally, plural home appliances are arranged in each house and some of the home appliances are produced by the same manufacturer. Examples of such the home appliances include a clothing treatment apparatus, a refrigerator, an air conditioner, TV and the like.

The plural home appliances are connected with each other for paring such that they may transceive a signal with each other. As embodying a clothing treatment apparatus as one example of the home appliances, the clothing treatment apparatus may mean a mechanism that performs washing, drying or both of the washing and drying. The clothing treatment apparatus may be categorized into a washing machine provided to perform a wash cycle functioned to separate and remove foreign substances from clothing and a dryer provided to perform a dry cycle functioned to remove moisture or water elements from clothing.

The washing machine provides a plurality of washing courses and washing options to perform the washing. One washing course forms a complete cycle configured of a wash cycle for removing foreign substances from clothing; a rinse cycle for separating the foreign substances of the clothing and washing detergent from each other; a dry-spin cycle for removing moisture or water from the clothing. The washing options may mean adjusting a level and degree of a rotation number (rpm) of a drum, a water temperature, a water level, a level of steam supply or the like and a frequency of the wash, rinse and dry-spin cycle, when performing the washing courses. Also, the washing options may be an algorithm or a control method that is set to adjust one or more of a repeated frequency of each cycle, a strength level in performing each cycle, a rotation number of a drum when performing each cycle, a degree of the water temperature or level, presence of steam supply and the duration of each cycle, when performing the wash, rinse and dry-spin cycle.

The dryer may provide plural drying courses and drying options to perform the drying for clothing. One drying course may form one complete cycle that implements an entire process of the dry cycle for removing moisture or wrinkles from clothing by supplying hot air or steam. One drying option may mean adjusting the rotation number of the drum, the temperature of hot air, a strength level of the hot air, the frequency of hot air supply and the duration of the drying course, when performing the drying course.

Recently, the households having both of the washing machine and the dryer to dry the clothing after washing are increasing. Accordingly, a process of drying clothes that are hung on a drying rack indoors or outdoors may be omitted only to make better use of a space and save the clothing treatment time and also improve sanitation by promoting complete drying of clothing. However, when having both of the washing machine and the dryer, a user has to input a washing course and washing options to the washing machine to wash laundry one by one and a drying course and drying options to the dryer to dry the washed clothing one by one again inconveniently.

FIG. 1 illustrates a system of a conventional clothing treatment apparatus to solve such inconvenience.

Referring to European Patent No. 1028188, a dryer 2 may be mounted on a top of a washer 1. The washer 1 may include an input unit 6, 7 provided in a front side of a cabinet to actuate the washer; and a touch-type interface unit 3 provided in an upper surface of the cabinet to transmit a washing course and a washing option to the dryer 2. The dryer 2 may include a dryer interface unit 4 provided in a lower surface of the cabinet and configured to communicate with the touch type interface unit 3.

Accordingly, the washer 1 and the dryer 2 may be in communication with each other. Once the washing course and the washing option are determined in the washer 1, the determined washing course and option may be transmitted to the dryer 2 via the interface unit 3,4. Hence, the dryer 2 may automatically determine a corresponding drying course and a corresponding drying option to the preceded washing course and option of the washer 1.

The dryer 2 may include only a water discharge tank 5 to collect the water discharged from the clothing but no input unit. The user needs not input the drying course and options one by one inconveniently.

However, when they transceive a signal via the touch type interface unit like the conventional clothing treatment apparatus, there is limitation that the washer 1 and the dryer 2 have to be provided in a multilayer structure. Accordingly, if the washer 1 and the dryer 2 have to be spaced apart from each other because of spatial limitation or interior design or beauty, the dryer 2 cannot communicate with the washer 2 disadvantageously.

In addition, the conventional clothing treatment apparatus may not provide power to the dryer 2 during the actuation of the washer 1. If the actuation is paused, the dryer 2 cannot receive the signal transmitted from the washer 1 disadvantageously.

Moreover, the conventional clothing treatment apparatus has to unconditionally accept the drying course and options determined by the dryer 2 or cannot change them, regardless of the user's intention.

If the area where the interface units face each other is changed by strong vibration that occurs in the washer 1, the communication between the washer 1 and the dryer 2 is cut off disadvantageously.

When the washer 1 and the dryer 2 are arranged side by side, different from what is shown in FIG. 1, it is not likely to guarantee the sealing between the washer 1 and the dryer 2. Also, if the ground is not uniformly level or vibration occurs in the home appliances, the communication might be easily cut off between the washer 1 and the dryer 2 spaced apart from each other. Because of that, the conventional clothing treatment apparatus has disadvantageous limitation that the washer 1 and the dryer 2 have to be arranged in a top mount type with a multilayered structure.

As mentioned above, there is a difficulty in set and maintain the pairing of the plural home appliances in related art. Even if the pairing is set, the user's intention is not reflected in realizing the pairing properly.

### DISCLOSURE

### Technical Problem

To overcome the disadvantages, an object of the present invention is to address the above-noted and other problems and to provide an online system that may facilitate communication between plural home appliances even if they are spaced apart from each other.

Another object of the present invention is to provide an online system that may also facilitate mutual searching and recognition even if the plural home appliances are spaced apart from each other.

A further object of the present invention is to provide an online system that may maintain a paired state between the plural home appliances even when the installation positons of the plural home appliances are changed.

A still further object of the present invention is to provide an online system that may determine and recommend a corresponding drying course and options to a washing course that is performed in a washer, when the plural home appliances include a washer and a dryer.

A still further object of the present invention is to provide an online system that may provide a dryer with the washing course and options performed in a washer, even when the operation of the dryer is paused or the power supplied to a main control unit is cut off.

A still further object of the present invention is to provide an online system that allows the user to determine whether the dryer receives the washing course and options performed in the washer even when the washer and the dryer are paired to each other or determine a corresponding drying course and options even after receiving the washing course and options.

### Technical Solution

To achieve these objects and other advantages and in accordance with the purpose of the embodiments, as embodied and broadly described herein, a refrigerator having an air processing apparatus comprises an online system comprising: a first home appliance comprising a first communication module configured to communicate with AP; a second home appliance comprising a second communication module configured to communicate with the AP; a server configured to specify and recognize the first and second home appliances based on AP information or port information of the first and second communication modules; and an external terminal comprising an input unit configured to receive an input of a command for requesting to set pairing between the first home appliance and the second home appliance; and a long range communication module configured to communicate with the server,

The external terminal may receive a list of the first and second home appliances by communication with the long range communication module, once the input is input to the input unit, and requests the pairing setting between the first home appliance and the second home appliance.

The first home appliance and the second home appliance may be paired to each other, once the first communication module and the second communication module receive a command for executing the pairing setting from the server.

The server may provide the list of the first and second home appliances to the external terminal by specifying the first home appliance and the second home appliance that are communicable with the same AP.

Upon completing the pairing setting, the pairing between the first home appliance and the second home appliance may be maintained even if the actuations of the home appliances are paused.

When receiving a command for requesting the pairing between the first home appliance and the second home appliance from the external terminal, the server may check connection states with the respective first and second communication modules and transmit a command for executing the pairing setting when connected to both of the first and second communication modules, and the server may notify the external terminal of the disconnection, when it is checked that at least of the first and second communication modules is disconnected from the other one.

The first home appliance may further comprise a first input unit configured to receive an input of a command for requesting the pairing with the second home appliance, and requests the pairing setting with the second home appliance to the first communication module, when an input to the first input is sensed.

The server may access the second communication module when receiving the request for the paring setting from the first communication module, and execute the pairing between the first home appliance and the second home appliance.

When receiving a command for requesting the pairing between the first home appliance and the second home appliance from the first communication module, the server may check a connection state with the second communication module and execute the pairing setting between the first home appliance and the second home appliance when connected to the second communication module, and when the communication with the second communication module is disconnected, the server may standby until the communication is connected or transmit state information of the second home appliance to the first communication module.

The first home appliance may ask the server for a list of pairable second home appliances, when an input to the first input is sensed, and generate setting information for executing the pairing with the second home appliance and transmit the generated setting information to the server, the list of the second home appliances is transmitted to the first communication module.

The first home appliance may further comprise a first display unit configured to convert the setting information into a specific signal and display or emit the specific signal, and the second home appliance may further comprise a second input unit configured to receive the specific signal displayed or emitted on the display unit, and when the specific signal is received, the second control unit converts the specific signal into the setting information and processes the setting information.

The first display unit may comprise a first liquid crystal configured to display the specific signal as a pattern

The second input unit may comprise a camera configured to photograph and recognize the pattern.

The first display unit may comprise a first speaker configured to emit the specific signal as a sound signal, and the second input unit may comprise a microphone configured to receive the sound signal.

The second home appliance may further comprise activation means configured to perform activation to receive the specific signal, and the second control unit may sense the reception of the specific signal, when the activation means are inputted.

The washer may comprise a first communication module configured to provide the executed washing course or option to the dryer out of the free washing courses and options.

The dryer may comprise a second communication module configured to receive the washing course or options provided by the first communication module; a control unit configured to determine or transmit corresponding drying course or options to the washing course or options provided by the first communication module out of the free drying courses and options; and a display unit configured to display the drying course or options determined or transmitted by the control unit outside.

The second communication module may receive and store the washing course or washing option provided by the first communication module, even when the actuation of the dryer is paused.

The second communication module may further comprise a communication control unit configured to determine a corresponding drying course or drying option to the washing course or washing option provided by the first communication module out of the free drying courses or drying options and providing the determined drying course and drying option to the display unit or the control unit, receiving the washing course or washing option from the first communication module.

The control unit may immediately transmit and display the determined drying course and drying option, when determining the drying course or drying option.

The dryer may further comprise an input unit configured to display the corresponding drying course or drying option to the washing course or washing option provided by the first communication module out of the free drying courses or drying options, and the control unit may transmit the determined drying course or drying option to the display unit to display it thereon.

The dryer may further comprise an input unit configured to display the corresponding drying course or drying option to the washing course or washing option provided by the first communication module out of the free drying courses or drying options, and the second communication module may ask and receive the first communication module for the executed washing course or washing option, when the input to the input unit tis sensed.

The dryer may comprise a second communication module configured to receive the washing course or options provided by the first communication module; and a display unit configured to display the drying course or options determined or transmitted by the control unit outside.

The second communication module may be configured to communicate with the server, even when the actuation of the dryer is paused, and the server may be configured to emit the drying course or drying option to the second communication module, when the drying course or drying option is determined.

The second communication module may ask the server for the drying course or drying option and receive the drying course and drying option, when the power supplied to the dryer is sensed.

The dryer may further comprise an input unit configured to display the drying course or drying option determined by the server, and the display unit may display the drying course or drying option received by the second communication module, when the input to the input unit is sensed.

The dryer may further comprise n input unit configured to display the drying course or drying option determined by the server, and the second communication module may ask the server for the drying course or drying option, when the input to the input unit is sensed.

### Advantageous Effects

Accordingly, the embodiments have following advantageous effects. According to at least one embodiment of the present disclosure, the online system is capable of facilitating communication between plural home appliances even if they are spaced apart from each other.

Furthermore, the online system is also capable of facilitating mutual searching and recognition even if the plural home appliances are spaced apart from each other.

Still further, the online system may maintain a paired state between the plural home appliances even when the installation positons of the plural home appliances are changed.

Still further, the online system may determine and recommend a corresponding drying course and options to a washing course that is performed in a washer, when the plural home appliances include a washer and a dryer.

Still further, the online system may provide a dryer with the washing course and options performed in a washer, even when the operation of the dryer is paused or the power supplied to a main control unit is cut off Still further, the online system may allow the user to determine whether the dryer receives the washing course and options performed in the washer even when the washer and the dryer are paired to each other or determine a corresponding drying course and options even after receiving the washing course and options.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### DESCRIPTION OF DRAWINGS

The present invention will become more fully understood from the detailed description given herein below and the accompanying drawings, which are given by illustration only, and thus are not limitative of the present invention, and wherein:

FIG. 1 illustrates a system of a conventional clothing treatment apparatus;

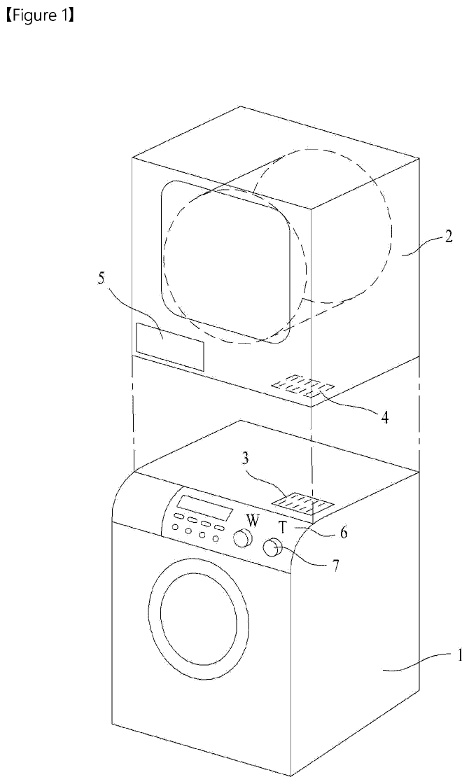

FIG. 2 illustrates a configuration of an online system according to the present invention;

FIG. 3 illustrates a structure of the online system;

FIG. 4 illustrates a structure of a clothing treatment apparatus;

FIG. 5 illustrates one embodiment of a method configured to set pairing in the online system;

FIG. 6 illustrates another embodiment of the method configured to set the pairing;

FIG. 7 illustrates a further embodiment of the method configured to set the pairing;

FIG. 8 illustrates the last embodiment of the method configured to set the pairing;

FIG. 9 illustrates one embodiment of using the pairing when the pairing is set in the online system; and

FIG. 10 is another embodiment of using the pairing.

### MODE FOR INVENTION

Referring to the accompanying drawings, exemplary embodiments of the present disclosure will be described in detail. Regardless of numeral references, the same or equivalent components may be provided with the same reference numbers and description thereof will not be repeated. For the sake of brief description with reference to the drawings, the sizes and profiles of the elements illustrated in the accompanying drawings may be exaggerated or reduced and it should be understood that the embodiments presented herein are not limited by the accompanying drawings.

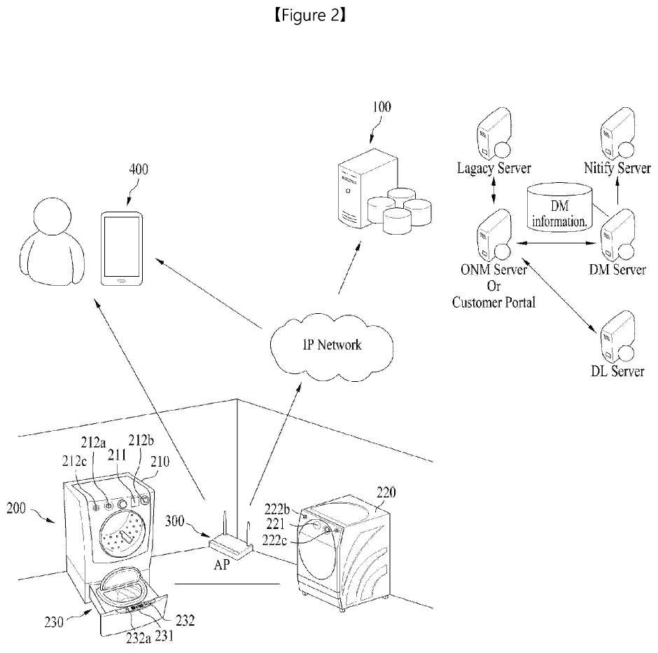

FIG. 2 illustrates a basic configuration of an online system that may realize paring (that means mutual recognition and connection) of plural home appliances 200. FIG. 2 illustrates a clothing treatment apparatus as the plural home appliances but it is for easy understanding of the present invention and other home appliances may be adopted.

A sever 200 has to be provided to set the paring between the plural home appliances 200 or manage all of the home appliances 200 provided as service objects. The home appliances 200 as the service objects may be communication-connected to the server and perform control commands transmitted from the server 100. The server may receive request for a service from the home appliances 200. Also, an internet site, an external terminal, a user terminal 400 and other auxiliary means, except the home appliances, may be provided to receive the request for the service there through.

In this instance, the external terminal or user terminal 400 means a device that is additionally provided such as a mobile phone, a smartphone, a notebook computer or a computer, except the home appliance and the server, which includes a communication module to communicate with an external device.

A provider who is responsible for managing the home appliances or providing a service through the home appliances may build the server to provide a remote control service. Also, if necessary, the user site mentioned above may be built.

The user may purchase and the home appliances 200 and receive a remote control service from the server 100. Such the home appliances may include a communication module to communicate with the server 100 and a client plane protocol to perform the command transmitted from the server. Meanwhile, an auxiliary device including the communication module configured to communicate with the server 100 and the client plane protocol configured to perform the command transmitted from the server. Meanwhile, an auxiliary device including such the communication module and the client plane protocol may be used for a conventional product no provided with the service of the server. The user may purchase the auxiliary device and connect it to the conventional product to receive the service.

The home appliance 200 desired to receive a remote control service provided by the server 100 may have a unique device ID and be registered to be managed.

When the home appliance 200 enables access to the server 100, the server may specify the home appliance based on the device ID. Together with information about characteristics of the corresponding home appliance (e.g., a product type, model information and etc.) may be registered in the server. In this instance, the device ID may be made, regardless of the information on the characteristics of the product (e.g., the product type or model information) or it may be coded together with the characteristic information. Accordingly, the server 100 may be configured to recognize the type or model information of the corresponding home appliance only based on the device ID.

The user is able to ask for a service through the home appliance 200 registered in the server 100.

Meanwhile, home appliances including a refrigerator, a washer, a vacuum cleaner, an electric oven, an air conditioner, a water purifier may not be always arranged near the user. As one example, the home appliances may be installed in a house and the user may be in the office, such that it may not be easy for the user to ask the server for a corresponding service through the home appliances 200. Each of such the home appliances may not have a display unit for receiving or displaying diverse information. Accordingly, the user may ask for the service through an external terminal 400 (e.g., a smartphone) that is always carried with himself or herself. For that, an application for realizing that function may be installed in the external terminal. The external terminal 400 such as the smartphone may be provided with various units configured to receive inputs or display diverse information such that the user can ask for the service quite conveniently.

In this instance, the external terminal 400 may directly communicate with the server 100 and the server 100 may communicate with the home appliances 210, 220 through the external terminal 400. Accordingly, the user is able to ask for a remote control service and figure out information about service performance and completion through the external terminal 400 easily.

The external terminal 400 may not directly communicate with the home appliance. In this instance, it is necessary to provide an additional hardware and software for the communication with the home appliance. The communication environment of the external terminal 400 may not be stable, compared with the communication environment of the home appliances. That is because the external terminal 400 may easily carried and mobile.

In contrast, it is general that the home appliance should be fixed in a building or room to be used such that the home appliance can stably communicate with the server through AP in the building. Accordingly, the external terminal may indirectly communicate with the home appliance through the server. With this, the cost increase of the home appliances may be prevented and the remote control service may be provided stably and consistently.

However, to ask for and perform such the service, the relation among the user's external terminal 400, the home appliance 200 of which a service the user desires to ask for and the server 100 has to be specified. In other words, when enabling access to the server 100 through the home appliance 200, ID of the home appliance is used in the access so as to specify the service object in the server. Unless the access is enabled not through the home appliance 200, it has to be determined how the home appliance is specified as the service object.

That is because the server 200 is theoretically able to provide such the remote control service to all of the home appliances set to receive the service, not only to the specific user and such the user's home appliances.

As one example, the user is able to access a user site and input a unique device ID of a home appliance that is the service object so as to ask for the service. When signing up on the user site, the user may be given a user ID and a password. Hence, the user may log in the user site and register all of the home appliances he or she possesses in the user site. The home appliances registered in the user site may be registered in the server, together with the corresponding user ID. That is enabled by the user ID and the devices IDs of the home appliances that are automatically pairing with the user ID transmitted from the user site. Through those processes, user information related with the user and home appliance information related with the home appliances may be stored in the server. The user information and the home appliance information are paring with each other to be stored in the server.

Meanwhile, the user may sign up on the user site through an application installed in the external terminal 400 and given the user ID and password. Accordingly, the user is able to register all of the purchased home appliances. The application may be provided for a remote control service of a specific home appliance or remote control services of plural home appliances.

As mentioned above, the user is able to access the user site and register the user information including the user ID and password in the server. Also, the user is able to directly register the home appliance in the server by using such the user information. In other words, the user is able to register the home appliance in the server through the home appliance itself. The home appliance may have an address of the server and an address of the user site such that it can transmit the user information and the home appliance information to the server to start communication between the two. At this time, the server may match the home appliance and the user.

Accordingly, the server may figure out that a specific user possesses a specific home appliance and a place where the specific home appliance is installed.

The registration of the home appliance 200 in the server 200 will be described in detail, referring to a process of activation.

In this cases, when the user is given ID, ID may be registered and managed in the server 100, together with the user's home appliance information, in other words, the unique information of the home appliance (e.g., the device ID). Such the user information and the home appliance information are matched such that one of the two may specify the other.

The service asked for by the user through the external terminal 400 or the home appliance 200 may be performed according to a command for the corresponding service transmitted to the server 100 by a system operator of the user site. Or, the user site, the external terminal or the home appliance may directly communicate with the server through open API of the server and ask the server for the management.

The server 100 may include a sever plane protocol for the management service and the server plane protocol may implement the requested remote control service, in connection with the client plane management protocol of the home appliance.

OMA DM (Open Mobile Appliance Device Management) protocol may be adopted as the protocol for implementing the above-noted management service between the server 100 and the home appliance 200. In case of using OMA DM protocol, the server may be DM server and the home appliance may be DM client. Here, other solutions rather than OMA DM may be adopted. The present embodiment adopts OMA DM protocol and the present invention is not limited thereto.

The server may be separated into several servers according to its functions.

The server 100 shown in FIG. 2 may be separated into DM server, Notification server, DL server, ONM server and Legacy server. When the server is separated according to the functions, the DM server may prepare for or implement another service in implementing a specific service. Accordingly, one or more services may be processed at the same time.

The servers may directly access corresponding objects and implement the corresponding services.

Some servers may enable direct access to the home appliance that is the service object. As one example, Notification server may directly notify the object home appliance and DM server may directly transmit firmware to the object home appliance.

The server 100 may have a different configuration according to contents of the management service. As one example, when only the firmware is included in the service contents, DM server, Notification server and DL server may provide the service and the other servers may not be needed. Also, when implementing the service without notifying the user of the firmware update, Notification server may not be needed.

In the present embodiment, the configuration of the server shown in FIG. 2 may be embodied in consideration of firmware update, software (including various contents) management, home appliance diagnosis, home appliance monitoring, refrigerator food expiration date notifying, refrigerator food list providing, and washing course upgrading. However, embodiments of the present invention are not limited to the configuration of the server shown in FIG. 2.

Hereinafter, the configuration of each element provided in the online system and the communication environment of the online system will be described in detail. The configuration is not necessarily provided and other elements may be further provided in describing the other structure of the present invention.

(1) The server may be configured as follows.

1) DM Server:

DM server may be configured to transmit a management command to a DM client. In other words, DM server may provide a management function of remotely processing the firmware update (e.g., Modem firmware/OS) management, the software management, the diagnosis management and the like. DM server may include a session management area, a security management area, a DM protocol process area and Syncll protocol engine area.

2) DL Server:

DL server may be configured to transmit a file to the DL client. In other words, DL server may provide a function of facilitating the user to download the file precisely by transmitting information about the file desired to transmit by using DD (Download Descriptor). In this instance, the DL client means the home appliance that receives the file. The downloaded file is configured of a firmware update package and a software management package. DL server may include a session management area, a package management area and a download area.

3) ONM Server or User Portal:

ONM server may be configured to interface with DM or DL server and Legacy server and realize business logic. The system operator may transmit a management command or inquire information via a management web page of ONM server.

The user portal provides a general user with some function of ONM server. At this time, an open API of DM server may realize the function. The user may ask DM server for the management service via the user portal.

4) Legacy Server:

Legacy server as one typical server in communication with ONM server may include a terminal information receiving server configured to receive the terminal information and a user information receiving server configured to receive the user information. In other words, Legacy server transmits the user information or the home appliance information to ONM server and provides information for realizing the business logic.

5) Notification Server:

Notification server may be configured to transmit a notification message of DM server to the home appliance. Notification server may include a session generation area and a schedule management area.

If the home appliance is located in a private network, a connection manager may be specially provided in the server to maintain the connection with the home appliance. After booting up, the home appliance may automatically ask for TCP connection and the connection manager may keep the requested TCP connection, such that DM server may transmit a notification message.

6) Open API:

The application of the mobile terminal (e.g., a smartphone) may manage the home appliances via Open API provided by DM server remotely. Open API will be described in detail later.

(2) The home appliance may include following elements.

1) Communication module:

The home appliance may include a communication module. The communication module may not be limited to the type of the home appliance and it may be a wire communication module or a wireless communication module.

As one example, the communication module may be a Wi-Fi accessible communication module or PLC or ZigBee accessible communication module.

2) DM Client:

A main function of DM client is configured to perform the management command of DM server. In other words, DM client may provide a management function configured to remotely process firmware update management, software management, diagnosis management and control management according to the management command of DM server.

3) DL Client:

DL client is configured to download a package file (e.g., a firmware update package, a software management package and the like) from DL server. DL server may receive a download server URL from DM client and access a download server to gain DD (Download Descriptor).

Then, DL client may download the package file.

4) Agent:

The agent may be configured to implement the management service command requested by the home appliance based on the management service contents. As one example, an update agent may create a new firmware by using the update package downloaded for the firmware update. The update agent may be realized in diverse types by a manufacturer.

5) Daemon:

Daemon may be configured to process the periodic access of the home appliance to the server. Unless a power cord of the home appliance is unplugged, Daemon may always keep an on-state. As one example, only when the power cord of the washer is connected to a socket even with the washer being power-off, Daemon may always keep its on state. If the power of the washer is asked to be power-on by the server, Daemon may transmit a command to a main board to apply electric power to the washer.

6) User Interface (UI):

The user's approval is needed to implement the management service and also the user may ask for the management service through the home appliance. TFT LCD window provided in the home appliance may be used as the user interface. Especially, a touch LCD or LED display may be provided as the user interface. An image for the management service may be popped up on a display. The user may input the user ID or password on such a management image. In this instance, the user ID and password may be given when the user sign up on the user site. The server system may identify the user based on the user ID and password. When the user is requesting the service through the terminal, the terminal may transmit the user ID and password, the device ID and service request information to the server system.

However, the above-noted user interface may not be provided all of the home appliances, because it cost high expense and space to realize the additional interface for the management service as well as the user interface for an original function of the home appliance.

As on example, it is not easy in the washer, the air conditioner, the vacuum cleaner, an electric oven and other similar home appliances to realize a display unit for displaying input means (e.g., letters) and much information.

Accordingly, it may require an external terminal (e.g., a smartphone) to implement the management service of such home appliances, because the external terminal such as the smartphone has a communication module, a memory, OS, input means and a display unit itself. Recently, external terminals having respective touch LCDs or LEDs are released and supplied and such external terminal are able to supplement or expand the limitation of the user interfaces provided in the home appliances.

Hereinafter, the communication environment between the home appliance and the server will be described.

Basically, any communication environments may be adopted only if proper to implement the management service.

FIG. 2 illustrates that the server 100 is communicable with a first home appliance 210 and a second home appliance 220, which have respective wireless internet communication modules, via AP (Access Point) 300.

Considering a communication channel from the home appliance 200 as a smart phone to the server 100, wireless communication is a common internet network after AP and wireless communication before AP is a private internet network. Each of the home appliances 210 and 220 is given a private IP and AP 300 has its original IP.

The server 100 has also IP and the IP of the server may be an original IP. Accordingly, the communication module of the home appliance (e.g., a Wi-Fi module) may have the original IP of the server. The home appliance is activated to access IP of the server and the communication between them may be facilitated.

Hence, the server 100 may control DM client to continuously transmit a signal DM server so as to locate the home appliance 200. AP 300 may transmit information about a port connected to a corresponding home appliance and its original IP to DM server such that the DM server can locate DM client. Alternatively, it may be possible for the home appliance to transmit information of AP 300 and the information about the port connected to AP 300 via AP. Accordingly, once the home appliance 200 transmits the device ID information to the server together with the above information, the server system may recognize the presence and place of the home appliance and access the home appliance according to the information. At this time, the user ID and password may be transmitted together.

Accordingly, the server 100 may locate a specific home appliance possessed by a specific user. When the home appliance or the user's external terminal asks the server for a specific service, the server 100 is able to determine the specific home appliance and implement the specific service.

Hereinafter, the contents and processes of the management service will be described.

(1) Signing in and activation of home appliances:

The user may be given the user ID and the password once accessing and signing in the user site.

The activation of the home appliance may mean a process of registering the user's home appliance 200 in the server 200. A window for inputting the user ID and password may be popped up on a display image of the home appliance such that the user can perform the process of the home appliance activation on the image.

Once the user inputs the user ID and password and then a command for the activation, the home appliance may transmit information about the user ID and password, the device ID and characteristics of the home appliance to the user site. At this time, the input user ID and password may be stored in the home appliance 200 to be used in user authentication.

The device ID may be preset in the home appliance 200 or automatically created in the home appliance when the activation is performed. Or, when the home appliance is purchased and powered on for the first time, the device ID may be automatically created.

The characteristic information of the home appliance may include home appliance model data, product code data, manufacture date, serial number data and the like

In addition, during the activation process, the home appliance may transmit a home appliance password, a service URL, a server ID and password together. The other information out of the information transmitted to the user site during the activation process, except the user ID and password may be automatically created or preset in the home appliance 200.

During the activation process, the above-noted information may be transmitted to the user site from the home appliance 200. The user site may register a corresponding home appliance in the corresponding user ID such that the home appliances used by the corresponding user for each user ID may be registered in the user site.

Hence, the user site may transmit the user ID and password, the device ID and the home appliance characteristic data and the like to the server 100. At this time, the server ID and password may be transmitted together with that information mentioned above.

The server 100 may perform authentication for the transmitted information. Once the transmitted information passes the authentication, the user ID and password, the device ID, the home appliance characteristic data and the like may be registered in the server. At this time, the device password may be transmitted together with the user information.

Such the activation process may be enabled regardless of the place, only when a communication environment allowing the user to access the server and the user site is provided. As one example, such the activation process may be performed by the dealer or at the place the home appliance is purchased instead.

(2) User's service request:

The user may request the service on a display screen of the corresponding home appliance 200 of which the service he or she wishes to get. As one example, the user is able to pop up an image of a desired service on the display and input the user ID and password to perform the service request. At this time, the corresponding home appliance may transmit the device ID together with the user ID and password, rather than the information related with the service request.

Also, the user may request a desired service through the user site. The user site may include a web page in which the user is able to ask for the management service. The user may ask for the desired management service one the web page.

Once the user requested the service, the user site may transmit data for the service request to the server system. At this time, the user ID and password may be transmitted together with the device ID.

Alternatively, the user may request the service by making a call to a call center. When requesting the service through the smartphone, the user implements a management service application downloaded in the smartphone and inputs the user ID and password only to request the service.

When requesting DM service for a remote service for the home appliance in diverse methods, the DM server implements the remote service for the home appliance. Upon completing the remote service, the home appliance may notify the DM server of the completion. When requesting the remote service through the external terminal, not the home appliance, the DM server may notify the external terminal of the completion of the remote service.

Accordingly, the user is able to request the remote service for the home appliance through the external terminal, not directly on the home appliance, and recognize the result of the service request.

(3) Home appliance remote control (Home appliance control):

It may be possible to control the home appliance remotely. The DM server may start the control management and such the control management may be implemented in Background. Accordingly, mutual operation with the user via MMI and interrupt occurrence may not be considered.

In case of the refrigerator, a list of control entries may include a refrigerator temperature, a freezer temperature, a convertible room temperature or mode (e.g., a freezing food mode, a meat mode, a vegetable mode, and the like), a special freezing control (including on/off of the special freezing mode), a refrigerator operation mode control (e.g., a normal mode, a test mode, a LQC mode, an exhibition mode, a smart diagnosis, and the like) and dispenser control (e.g., an ice mode, a water mode, an ice cube mode, and the like).

In case of the washer, the list of control entries may include a power off, an operation actuating, an operation pausing and the like. In addition, the list of the control entries may include reservation change, washing course selection, washing course option selection, steam selection and the like. It may be also controlled to perform a wrinkle-free function after the completion of the washing course. Such control management may be enabled through the application downloaded in the smartphone by DM server via the Open API.

(4) Monitoring:

The monitoring is a service related to the monitoring of the home appliance. When the monitoring is requested, the home appliance may transmit monitoring data to the server system.

As one example, when asking the washer for the monitoring data, the washer may implement a program for monitoring to collect the monitoring data and transfer the collected data to the server. At this time, the monitoring data may include a monitoring command implementing time, monitoring data occurrence data. Upon requesting the monitoring implementation, it may be controlled to start the monitoring and repeatedly transmit the monitoring data.

The monitoring service may be requested through the external terminal (e.g., a smartphone) and the user may inquire the result of the request. An interface of Open API for the monitoring may be configured to provide both of the start and end interfaces.

Hereinafter, the process of the communication between the home appliance 200 and the server 100 will be described in detail. The home appliance may be communicable with AP 300 in a household first such that it may have a communication module. Specifically, the communication module may include a Wi-Fi communication module.

For the communication with the home appliance, the Wi-Fi communication module may support a setting mode for connecting communication and a use mode for communicating.

In other words, the setting mode has to be implemented to facilitate the communication of the Wi-Fi communication module. Upon connecting the communication in the setting mode, the setting mode is converted into the use mode. Accordingly, the setting mode of the Wi-Fi communication module has to be implemented first for the communication connection.

Here, the setting mode is a mode for facilitating communication with AP, accordingly, an AP mode. The use mode may be a state where the home appliance is able to communicate with the server via AP, in other word, a state where data is able to be transceived to implement the remote management service anytime. Simply, the use mode may refer to as the connection mode or the standby mode.

The setting mode may be realized by the external terminal.

In this instance, the externa terminal may refer to a device that includes a Wi-Fi communication module, letter input means, display means, CPU, OS and storage means. As one example, the external terminal may include a notebook computer or a smartphone.

The external terminal may be provided to access the Wi-Fi communication module to AP 300, instead of the Wi-Fi communication module or the home appliance. Accordingly, in the setting mode, external terminal 400 may receive inputs of SSID (Service Set Identifier) information of AP 300 and user information for registering the home appliance.

The external terminal 400 may display accessible SSIDs and the user may select one of the SSIDs that will be continuously accessed, for example, SSID that is used in a household. Here, when Wireless LAN is locked for the security setting, the user has to select one of the SSIDs and input a password of the selected one on the external terminal. Accordingly, the SSID information may include the SSID password.

The Wi-Fi communication module is switched into the use mode once receiving such the user information and the SSID information. When inputting the SSID information and the user information, such the information may be automatically stored in the communication module. Accordingly, consistent communication may be enabled without additional implementation of the setting mode. In other words, the external terminal is able to automatically access the AP according to the information. The home appliance 200 is able to communicate with specific AP 300 by wireless LAN, in other words, short range communication may be enabled.

Meanwhile, the communication module may have an address of the server to desired to access by the user or an address of the user site. Here, the server address or the user site address may have fixed IP. Accordingly, in the use mode, the home appliance 200 is able to communicate with the server 100 via the AP 300. When switching into the use mode, the user information and the home appliance information that are stored in the home appliance may be automatically registered in the server 100 via the AP. The user site may be used so as to authenticate the user information and the home appliance information transmitted by the home appliance.

In this instance, the user information may be the information preset in the server 100 through the user site. Accordingly, the server 100 may compare the user and home appliance information preset through the user site 60 with the information received in the use mode switched from the setting mode and store the result of the comparison. Hence, the server 100 may recognize a specific user and a specific home appliance possessed by the specific user, especially, the location of the specific home appliance.

Meanwhile, the Wi-Fi communication module may have a static address for implementing the setting mode. The user may input the static address to the external terminal 400 (e.g., a smartphone or a notebook computer) and access the setting mode, in other words, a website of a Wi-Fi modem setting mode set in the home appliance. The static address may be designated as 192.1.xx.xx. The access to the setting mode of the external terminal 400 means expanding the input means and display means of the communication module by using the external terminal 400.

Upon access the website of the setting mode, a home appliance registration page may be displayed and the user may register the home appliance in the server by inputting required information.

Accordingly, the user is able to switch the current mode of the communication module from the setting mode to the use mode through the external terminal 400 easily. That means that no hardware such as the additional input or display device has to be added or modified. The additionally provided external terminal 400 may be used and the rise of the home appliance price may be prevented accordingly.

Meanwhile, one or more tips of SSID information that will be connected to a static address for access the setting mode may be displayed on the home appliance 200 in the setting mode. The user is able to easily input the static address to the external terminal 400 or access the SSID of the communication module through the external terminal 400.

As one example, an image on which the user accesses the setting mode by inputting the static address is shown in the drawing. User AP, in other words, an image for inputting SSID information desired to access (e.g., SSID name and/or SSID password) and another image for inputting the user ID and password are also shown.

The user ID and password may be preset through the user site mentioned above. Accordingly, upon registering the input information, the home appliance 200 may be registered in the server 100.

Only in a state where the setting mode of the home appliance 200 is activated, the external terminal 400 may be set to access the web page of the setting mode. That is to fit the home appliance desired to be connected with the server to the home appliance substantially connected with the server.

Specifically, the user may input the static address of the communication module provided in the home appliance 200 on the smartphone, in a state where the setting mode of the home appliance 200 is activated, such that the smartphone and the home appliance can communicate with each other. accordingly, the home appliance may receive user AP information, which will be connected with the user information, from the smartphone and it may be then connected with AP. Once connected with AP, the home appliance may switch the setting mode to the user mode. At this time, the home appliance may be normally registered in the server through the authentication process with the server or the user site.

In a state where the setting mode of the home appliance 200 is activated, the smartphone may directly access the communication module of the home appliance 200. When the Wi-Fi communication is connected between the smartphone and the home appliance, the home appliance may be connected to User AP in an actual household.

Hence, the user may quickly register the home appliance in the server 100 and use the remote service later. Once such the communication is connected, the communication may be automatically connected later after the power application.

Meanwhile, the external terminal 400 may be used not only as the auxiliary means for the communication connection of the home appliance but also as the means for facilitating the management service. Similarly, the expanded input and display means of the external terminal 400 may be utilized.

To request the remote service of the home appliance through the external terminal 400, the external terminal 400 may include an application program configured to request and implement one or more of the remote control, the remote diagnosis, the firmware or software update and the monitoring of the home appliance 200.

Upon implementing an initial stage of the application program, the user information may be transmitted to the server and the requested service may be implemented by the communication with the corresponding home appliances to the user. Meanwhile, the application program may display home appliances of which remote services can be provided. The application program may allow the user to select one or more of the home appliances the user actually possesses. Unless the user's home appliances re registered, the user may register the home appliances in the server through the application program.

Hence, the server may figure out whether the user's home appliance is registered. Accordingly, the external terminal may display the presence of the registered home appliance. If there are two or more registered home appliance, the user may select one specific one of the registered home appliances to get a service.

As one example, when the user's washer 210 and dryer 220 are registered in the server, the user may select the washer and remotely control the washer. In contrast, the user may select the dryer and remotely control the dryer. After that, the user may request a remote control of one specific home appliance through the application program.

Meanwhile, unless the user's home appliances are registered in the server, the user may register them in the server and the registration process is equal to the process mentioned above.

The application program may be provided to a specific group of home appliances (e.g., a washer, a dryer, a refresher and the like). Accordingly, the user's implementation of the application program may mean the user desires a service of a specific group or a specific one. The user's implementing of the application program may mean the user's logging in the server by inputting the user information of the specific group or one. After logging in the server, the server may determine whether the home appliance is registered in the server together with the user information.

Unless the home appliance related with the application program is registered in the server after the user logging in, the external terminal may not display the home appliance and then the user may register a new home appliance through the external terminal. In other words, when the washer is registered, only the washer may be displayed. When a plurality of home appliance is registered, the plural home appliances may be displayed. The user may touch one of the home appliances for the remote service and then request the remote service for the touched home appliance.

Meanwhile, in registering the home appliance in the server, it is important to allow the server to figure out which user the home appliance belongs to and where it is located. Accordingly, the user information has to be transmitted to the server, when registering the home appliance. Also, information about AP address has to be transmitted to the server. The access to the setting mode of the Wi-Fi communication module may be for matching the home appliance the user information such that signals need not be transceived between the external terminal and the home appliance.

Hereby, the method or process of registering the user or home appliance in the server and the characteristics of the home appliance and characteristics of the online service are described in detail.

Hereinafter, one embodiment for realizing the online service of the home appliance by using the externa terminal after registering the user or the home appliance in the server will be described in detail.

The washer may include a remote control selection unit. When remote control is selected, such information may be transmitted to the server. In case the user requests information about a current state of the washer via the application program, the server may receive such the information.

When easily explained, the remote control means the control for the operation of the washer through the application program of the external terminal (e.g., a smartphone). To facilitate the remote control, the server may be provided between the smartphone and the washer.

Hereinafter, the activity relation among the server for the remote control service, the home appliance and the external terminal and the display state on the home appliance and the external terminal will be described in detail.

A logging-in step for logging in the server 100 by transmitting the user information to the server through the external terminal 400 may be performed. For that, the application implementation, the home appliance registration and the input of the user information including the user ID and password may be performed first.

Once the user logs in the server 100 through the external terminal 400, the server 100 specifies a home appliance for the remote control service (or the remote control) based on the user information. Specifically, the server 100 may specify who the home appliance belongs to and where it is located, in other words, a home appliance that will receive the remote control. The server also checks whether to set the remote service activation of the specified home appliance.

The specifying process of the home appliance 200 may be performed in diverse methods.

First of all, the server 100 may match the user information the user information transmitted from the external terminal 400 and then specify the home appliance based on the home appliance information stored in the server 100.

Alternatively, the server may specify a home appliance for the remote service based on the home appliance information received from the external terminal together with the user information.

In this instance, the application implemented in the external terminal may be only for one home appliance (e.g., a washer). In other words, the user information and the home appliance information are matched one to one. Accordingly, the server may figure out which user intends to remotely control his or her specific home appliance so as to specify the home appliance based on the user information.

Alternatively, the application implemented in the external terminal may be for a plurality of home appliances. In other words, the plurality of the home appliances may be matched to the user information. The user may log in the server or select one of the home appliances for the remote control. As one example, the user may select the washer of the washer and dryer. Accordingly, the server may also figure out which user intends to remotely control his or her specific home appliance and specify the home appliance (e.g., the washer) based on the user information.

The checking step may be performed by the server's requesting information about the state of the home appliance 200 and the home appliance transmitting the state information to the server.

Once the state information is transmitted to the server 100, the server 100 transmits the state information to the external terminal.

The server 100 may figure out the model number of the home appliance based on the home appliance information transmitted from the home appliance or stored in the server 100 such that the server 100 may recognize information about diverse variable operations that the model has.

In case of the washer, such variable operation information may include a washing or drying course and various options configured to perform each course. The options may include a washing level (e.g., a contamination level), the number of rinsing cycles, the temperature of wash water, a dry-spinning level, presence of steam use and the like. Such the variable operation information may be set for respective specific models. As one example, the presence of the steam use may not be provided in the variable operation information for a model having no steam function. Also, the selectable courses and the number of the courses may be variable for respective models.

Accordingly, when the home appliance is in the remote service activation setting mode, the server may specify variable operation information that is corresponding to the home appliance and transmit the variable operation information of the home appliance to the external terminal 400.

The plurality of the home appliances 200 may include a washer 210 and a dryer 220, in other word, the home appliances 200 may include a first home appliance 210 and a second home appliance 220. The washer 210 may be provided as the first home appliance 210 and the dryer 220 may be provided as the second home appliance 220.

The home appliances 200 may further include a third home appliance 230. The third home appliance 230 may be a second washer 230.

When the plurality of the washers is provided, they may be arranged in a multilayer structure or independently spaced a preset distance apart from each other.

The dryer 220 may be independently spaced a preset distance apart from the washer 210 or disposed on a top or bottom of the washer 210. As shown in FIG. 2, a plurality of dryers 220 may be provided.

The washers 210 and 230 and the dryer 220 may be communicable with the server 100 via the AP 300 or with each other directly.

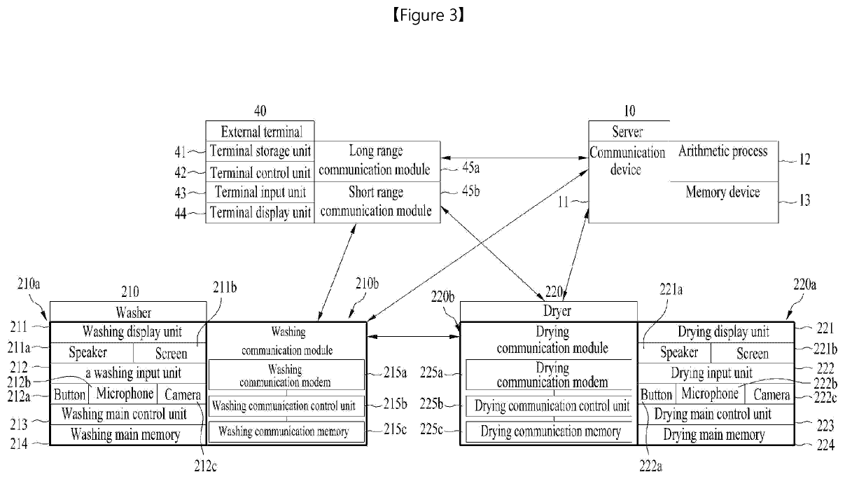

FIG. 3 is a block diagram illustrating a configuration of a control device or electric/communication device that may enable the washer 210 and the dryer 230 to communicate with the server 100 or the external terminal 400.

The external terminal 400 according to the present invention may include a terminal input unit 43 configured to input a command for actuating the external terminal; a terminal display unit 44 configured to display a state of the external terminal 400 and the information received from the server 100; a long-range communication module 45a configured to communicate with the server 100 arranged in a remote place; a short-range communication module 45b configured to communicate with the home appliances 200 arranged nearby; a terminal control unit 42 configured to control components of the external terminal; and a terminal memory unit 41 in which the information received from the terminal input unit or the communication module is stored.

The short range communication module may be a device configured to communicate with a communication device located in a preset short distance of Radio Frequency (e.g., WIFI, Bluetooth, ZigBee and the like). The long range communication module may be a device configured to communicate with a communication device located in a long distance by using a base station or communication network (e.g., 3G, LTE, 4G and the like).

The server 100 according to the present invention may include a communication device 11 configured to communicate with the external device 400 or the home appliance 200 or the AP 300; an arithmetic processor 12 configured to generate or analyze diverse control signals; and a memory device 13 provided to store the data generated or received from the external terminal, the home appliance and the arithmetic processor.

The washer 210 may include a washing main control unit 210a configured to control the operation of the washer 210; and a washing communication module (or a first communication module 210b) configured to communicate with the external terminal 400 or the AP 300 and the dryer 230.

The washing main control unit 210a may be in a power-cut-off state when the washer 210 is paused or ended and standby electric power consumption may be prevented. The first communication module 210b may be in a consistently power-supplied state and keep a communicable state with the server.

The washing main control unit 210a may include a washing load controller (or a first controller 213) configured to control each of the components provided in the washer 210; a washing input unit (or a first input unit 212) configured to input a command to the washer 210; a washing display unit (or a first display unit 211) configured to display a state of the washer 210 or the information generate in the washing load controller 213; and a washing main memory 214 provided to store the data received from the washing communication module 210b or generated in the washing load controller 213.

Specifically, the washing input unit 212 and the washing display unit 211 may be provided in an exterior surface of the cabinet. The washing input unit 212 may include a washing button 212a configured to input a washing course option or power; a washing microphone 212b configured to receive a sound signal; and a washing camera 212c configured to receive an image signal. Also, the washing display unit 211 may include a washing display or a washing liquid crystal 211b configured to display the information as an image; and a washing speaker 211a configured to display a sound signal. The washing display unit 211 may be provided as a touch panel to function as the washing input unit.

The washing communication module 210b may be connected with the washing control unit 210b by communication. The washing communication module 210b may include a washing communication modem 215a configured to communicate with at least one of the AP 300, the external terminal 400 and the dryer 220; a washing communication control unit 215b configured to control the washing communication modem 215a; and a washing communication memory 215c provided to store the information received from the washing communication modem 215a or the information generated in the washing communication control unit 215b.

The washing communication module 210b may perform short range communication and long range communication with the external terminal 400.

The dryer 220 according to the prevent invention may include a drying main control unit (or a second control unit 220a) configured to control the operation of the dryer 220; and a drying communication module (or a second communication module 220b) configured to communicate with the external terminal 400 or the AP 300 and the washing communication module 210b.

The drying main control unit 220a may be in a power-cut-off state when the dryer 220 is paused or ended and standby electric power consumption may be prevented. The drying communication module 220b may be in a consistently power-supplied state and keep a communicable state with the server.

The drying main control unit 220a may include a drying load control unit (or a second controller 223) configured to control each of the components provided in the dryer 220; a drying input unit (or a second input unit 222) configured to input a command to the dryer 210; a drying display unit (or a second display unit 221) configured to display a state of the dryer 220 or the information generate in the drying load controller 223; and a drying main memory 224 provided to store the data received from the drying communication module 220b or generated in the drying load control unit 223.

Specifically, the drying input unit 222 and the drying display unit 221 may be provided in an exterior surface of the cabinet. The drying input unit 222 may include a drying button 222a configured to input a washing course option or power; a drying microphone 222b configured to receive a sound signal; and a drying camera 222c configured to receive an image signal. Also, the drying display unit 221 may include a drying display or a drying liquid crystal 221b configured to display the information as an image; and a drying speaker 221a configured to display a sound signal. The drying display unit 221 may be provided as a touch panel to function as the drying input unit.

The drying communication module 220b may be connected with the drying control unit 220b by communication. The drying communication module 220b may include a drying communication modem 225a configured to communicate with at least one of the AP 300, the external terminal 400 and the washer 210; a drying communication control unit 225b configured to control the drying communication modem 225a; and a drying communication memory 225c provided to store the information received from the drying communication modem 225a or the information generated in the drying communication control unit 225b.

The drying communication module 220b may perform short range communication and long range communication with the external terminal 400.

Meanwhile, in case the washer 210 includes an additional second washer 230, the additional second washer 230 may have the same configuration with the washer 210.

As a result, the washer 210 and the dryer 220 may be communicable with each other via the washing communication module 210b and the drying communication module 220b or they may be communicable with the external terminal 400 and the server 100.

In this instance, even the plurality of the washers 210 and the plurality of the dryer 220 are provided, each of the washers 210 and dryers 220 has the respective configurations that are equal to what is described above.

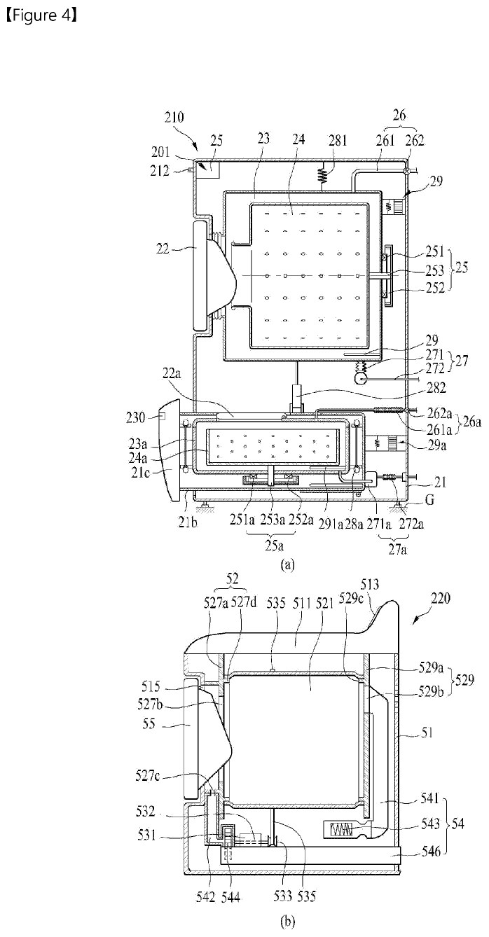

FIG. 4 illustrates specific components of the clothing treatment apparatus 200 according to the present invention shown in FIG. 2.

FIG. 4 (a) illustrates the structure of the washer 210 provided in the clothing treatment apparatus and FIG. 4 (b) illustrates the structure of the dryer 220 provided in the clothing treatment apparatus.

Referring to FIG. 4 (a), the washer 210 may include a cabinet 21 defining an exterior design; a tub 23 provided in the cabinet 21 and configured to hold water; a drum 24 rotatably provided in the tub 23; a drive unit 25′ coupled to the tub 23 and configured to rotate the drum 24; a water supply unit 26 configured to supply water to the tub 23; and a water discharge unit 27 configured to discharge the water from the tub 203.

The washer 210, 230 may further include a hot air supply unit or a heater 29 configured to supply hot or heated air to the tub 230; a tub opening formed in the tub 23; and a door 22 provided to open and close a cabinet opening.

The water supply unit 26 may include a water supply valve 262 and a water supply pipe 261. The water discharge unit 27 may include a water discharge pump 271 and a water discharge pipe 272.

The drive unit 25 may include a stator 251 coupled to the tub 23 and configured to generate a rotating magnetic field; a rotor 252 rotatable by the rotating magnetic field; and a shaft 253 rotatable together with the rotor 252 to rotate the drum.

Vibration of the tub 23 may be damped by a support portion 28 of the cabinet 210. The support portion 28 may include a damper 282 and a spring 281. The damper may connect the cabinet 21 and the tub 230 with each other to damp the vibration.

Meanwhile, when the washer 210 is a combined clothing treatment apparatus, the second washer 230 may be further provided. The second washer 230 may be independently provided with respect to the washer 210. Hereinafter, the second washer 23 mounted underneath the washer 210 in a multilayer structure will be described.

The second washer 230 may include a second tub 23a provided in a lower or upper portion of the tub 230 and configured to hold water; a second drum 24a rotatably mounted in the second tub 23; a second drive unit 25a coupled to the second tub and configured to rotate the second drum 24a; a second water supply unit 26a configured to supply water to the second tub 23a; and a second water discharge unit 27a configured to discharge water from the second tub 23a.

When it is provided in a lower portion of the tub 23 as a top load type, the second tub 23a may be mounted in a drawer 21b retractable from the cabinet 210.

The second water supply unit 26a may include a second water supply valve 262a and a second water supply pipe 261a. The second water discharge unit 27a may include a second water discharge pump 271a and a second water discharge pipe 272a.

The second drive unit 25a may include a second stator 251a coupled to the second tub 23a and configured to generate a rotating magnetic field; a second rotor 252a rotatable by the rotating magnetic field; and a second shaft 253a rotatable together with the second rotor 252a to rotate the second drum 24a.

Vibration of the second tub 23a may be damped by a second support portion 28a of the cabinet 21.

The drive unit 25, 25a, the water supply unit 26, 26a, the water discharge unit 27, 27a, the hot air supply unit 29 may repeat driving and pausing according to the course or options that are set in the control panel 100 or the control unit 400.

As one example, the water supply valve 261, 261a may be open according to the input course and options to rotate the drive unit 25, 25a and drive the water discharge pump 271, 271a.

As shown in FIG. 4 (b), the dryer 220 may include a drying cabinet 51; a drying drum 52 provided in the drying cabinet and configured to hold clothing; and a drying unit 54 configured to supply air to the drying drum.

The drying cabinet 510 may include a front panel 517 defining a front surface of the dryer; and a dryer opening 515 provided in the front panel and configured as a channel of the clothing into the drying drum 52.

Meanwhile, the drying cabinet 51 may further include a drying cabinet cover 511 defining an upper surface of the dryer. A drying control panel 513 may be provided in the drying cabinet cover to control the operation of the dryer. The control panel 513 may include a drying load control unit 213 configured to control a drying unit 54, a drying drive unit 53 which will be described later.

The drying drum 52 may be configured as a drum body 521 providing a predetermined space for holding clothing. When the drum body 521 may be formed in a cylinder shape with both opposite open sides, an open side located in a front surface of the drum body 521 may be supported by a front support portion 527 and the other open side located in a rear surface of the drum body 521 may be supported by a rear support portion 529.

The front support portion 527 may include a first support body 527a fixed in the drying cabinet; a body through hole 527b penetrating the first support body to facilitate communication between the dryer opening 515 and the drying drum 52; and a front flange 527d provided in a circumferential surface of the body through hole 527b and provided to rotatably support the open front surface of the drying drum.

The rear support portion 529 may include a second support body 529a fixed in the drying cabinet; and a rear flange 529c provided in the second support body and configured to rotatably support the open rear surface of the drying drum.

The drying unit 54 may include an air discharge unit 542, 544, 546 configured to discharge air outside from the drying drum via the front support portion 527; and an air supply unit 541, 543 configured to supply air to the drying drum via the rear support portion 529.

In this instance, an air outlet hole 527c may be further provided in the front support portion to discharge air from the drying drum 52 to the air discharge unit and an air inlet hole 529b may be further provided in the rear support portion 529 to drawn the air discharged from the air supply unit into the drying drum 52.

The air supply unit may include an air supply duct 541 connected to the air inlet hole 529b; and a heat exchanging unit 543 configured to heat the air drawn into the air supply duct 541.

The air discharge unit may include a connection duct 542 connected to the air outlet home 527c; an air discharge duct 546 configured to guide the air drawn into the connection duct outside the drying cabinet 51; and a fan 544 provided in the connection or the air discharge duct and configured to blow the air inside the drying drum 52 towards the connection duct 542.

Meanwhile, different from what is described above, the drying unit 54 may be configured to sequentially dehumidify and heat the air discharged from the drying drum 52 and then supply the air to the drying drum 52 again. In this instance, the air discharge duct 546 has to be connected to the air supply duct (a free end of the air supply duct has to be connected to the air discharge duct). The heat exchanging unit 543 may include a dehumidifying unit configured to dehumidify moisture from the air by cooling the air inside the air discharge unit; and a heating unit configured to heat the air having penetrated the dehumidifying unit.

The drying drum 52 and the fan 544 may be rotatable by the drying drive unit 53. In other words, the drying drive unit 53 may include a motor 531; a motor shaft 532 rotatable by the motor; a pulley 533 fixed to a first free end of the motor shaft; and a belt 535 provided to connect a circumferential surface of the pulley to a circumferential surface of the drying drum. In this instance, the fan 544 may be connected to a second free end of the motor shaft.

Accordingly, the washer 210 or the second washer 230 according to the present invention may perform a wash cycle, a rinse cycle and a dry-spin cycle. The dryer 220 according to the present invention may perform a dry cycle.

Hereinafter, one embodiment configured to set pairing between the plurality of the home appliances based on the above-noted configuration will be described.

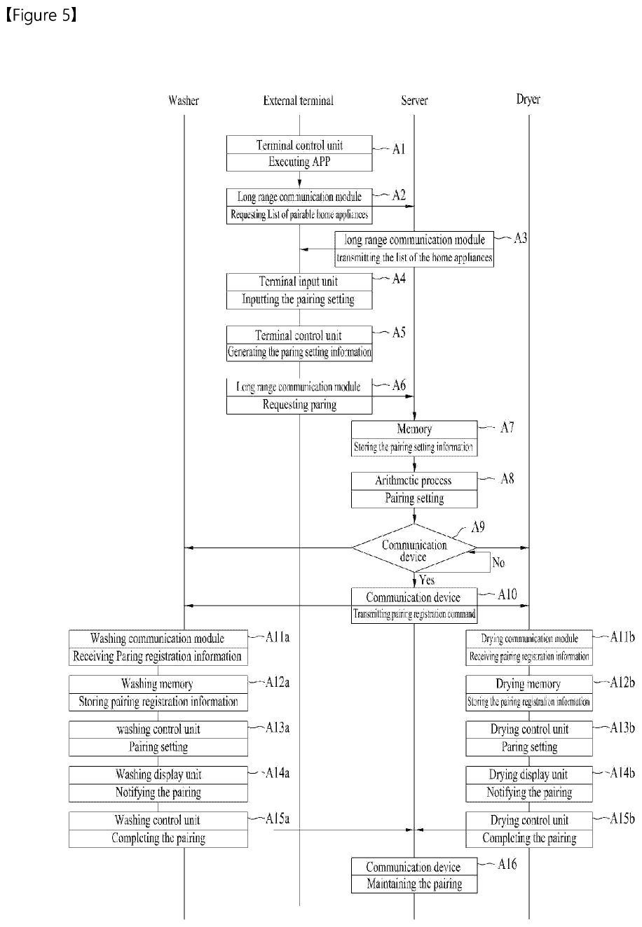

FIG. 5 illustrates one embodiment of a method configured to set pairing between the first home appliance 210 or the washer 220 and the second home appliance 220 or the dryer through the external device 400 and the server 100.

The online system according to the present invention may include a first home appliance 210 having a first communication module configured to communicate with AP 300; a second home appliance 220 having a second communication module configured to communicate with the AP 300; a server 100 configured to specify and recognize the first and second home appliances based on AP information or port information of the first and second communication modules; a terminal input unit configured to receive an input of a command configured to request the pairing between the first and second home appliances and an external terminal 400 having a long range communication module configured to communicate with the server.

When the terminal input unit receives the input, the external terminal 400 may communicate with the server via the long range communication module and receive a list of the first and second home appliances to request the setting of the pairing between the first home appliance and the second home appliance. The first and second home appliances may receive a command for implementing the pairing setting from the server via the respective first and second communication modules and be paired to each other.

The server 100 may specify the first home appliance 210 and the second home appliance 220 that are communicable with the same AP 300 and then provide the external terminal 400 with the list of the first and second home appliances.

Even when the first and second home appliances 210 and 220 are stopped upon completion of the pairing setting between them, the first and second communication modules may be communicable with the server so as to keep the pairing state.

When receiving the command configured to request the pairing between the first and second home appliances from the external terminal 400, the server 100 may check respective connection states of the first and second communication modules and transmit a command configured to implement the pairing once it is checked that both of the first and second communication modules are connected. If it is checked that at least one of the first and second communication modules is disconnected from the other, the server may notify the external terminal.

Hereinafter, referring to FIG. 5, one embodiment of the home appliances configured of a washer and a dryer will be described.

When the user inputs a command showing the user's intention to implement the application program through the terminal input unit 43, the terminal control unit 42 of the external terminal may perform an implementing step A1 for implementing the preset application program to facilitate communication with the server 100.

Once the implementing step is performed, the terminal control unit 42 may control the long range communication module 45a to perform a list requesting step A2 for requesting a list of home appliances that can be paired to each other. In the list requesting step A2, the server 100 may receive a signal for requesting the list of the home appliances from the external terminal 400 and the communication device 11 and search a list of home appliances that are able to be paired to each other through the arithmetic processor 12. Specifically, the server 100 may search a home appliance 200 that is pre-registered or specified by a specific user in the memory device 13. Alternatively, the server 100 may search the home appliances 200 matched to the same user ID or registered in the server 100 via IP of the same AP 300 and specify them as a list of the home appliances that can be paired to each other.

The server 100 may perform a list transmitting step A3 for transmitting the list of the home appliances that can be paired to each other to the external terminal 400 through the communication device 11.

Upon receiving the list through the long range communication module 45A from the server 100, the external terminal 400 may display the home appliances that can be paired to each other on the terminal display unit 44 by using icons, letters, images and the like. Accordingly, the user may perform a pairing setting input step A4 for inputting home appliances desired to pair from the list. As one example, the use may touch icons of the washer 210 and the dryer 220 displayed on the terminal display unit 44 and input the command configured to set the pairing.

The terminal control unit 42 of the external terminal 400 may perform a setting information generating step A5 for directly generating the pairing setting information provided to perform the pairing. The generating of the setting information is generating a profile and it may be an executable file configured to set the pairing or the information having an original device ID and a serial number of the home appliance and state information, after transmitted to the server 100 and the home appliance 200.

The external terminal 400 may directly generate the setting information through the application program and transmitted the generated information to the server 100. Specifically, the terminal control unit 42 of the external terminal 400 may perform a pairing requesting step A6 for requesting the pairing setting of home appliances desired to be paired through the long range communication module 45a.

Upon receiving a command configured to request the pairing setting of specific home appliances from the external terminal 400, the server 100 may perform a setting information storing step A7 for storing the paring setting information in the memory device 13. That is to prevent the repetition of additional requests to the external terminal 400 by keeping the setting information until the pairing of the home appliances is complete.

The server 100 may perform a pairing setting step A8 for implementing the pairing between the home appliances of which the pairing is requested by using the setting information. The pairing setting step A8 may be a step for confirming a system that controls the home appliances of which the pairing is requested to recognize each other via the server 100 and transmit signals with each other. In other words, the pairing setting step A8 may mean the step for executing the pairing of the home appliances 100 managed in the server 100.

Once the pairing setting step A8 is completed, the serve 100 may perform a communication connection checking step A9 for checking whether the home appliances, of which the pairing is requested, are communication-connected with the communication device 11 of the server 100.

When it is checked that any one of the pairing-requested home appliances is not communication-connected with the communication device 11 of the server 100, the server 100 may notify the external terminal of the list of the home disconnected appliances.

Meanwhile, when it is checked in the communication connection checking step A9 that all of the pairing-requested home appliances are communication-connected, the server 100 may perform a pairing registration command transmitting step A10 for performing the pairing between the home appliances by transmitting the pairing setting information to the home appliances 200 through the communication device 11 or transmitting registration information having a pairing execution program to the home appliances 200 for the server 100 to actually realize the set pairing.

The home appliances 200 may receive the setting information or registration information from the server 100 and recognize the other home appliances, transmit or receive information to each other by the respective control units execute the pairing.

The pairing-requested home appliances 200 may include a washer 210 and a dryer 220.

The washer 210 and the dryer 220 may perform a registration information receiving step A11a, A11b for receiving the registration information from the server 100 through the washing communication module 210a and the drying communication module 220a. The washer 210 and the dryer 220 may perform the actual pairing by executing the registration information.

Hence, the washer 210 and the dryer 220 may perform a registration information storing step A12a, A12b for storing the registration information in a communication memory unit 215c and 225c provided in the communication module or the main memory 214, 224. Accordingly, the pairing set state may be maintained until the registration information is deleted or updated.

The washer 210 and the dryer 220 may perform a paring executing step A13a, A13b for substantially executing the mutual pairing by processing the registration information to the respective communication control units 215a and 225a. The paring step may a step for setting a state where the respective control units of the washer 210 and the dryer 220 substantially recognize each other and transceive information with each other.

The washer 210 and the dryer 220 may perform a notifying step A14a, A14b for notifying that the pairing is set via the respective display units 211, 221. Accordingly, the user is able to recognize that the pairing set through the external terminal 400 is normally executed.

The washer 210 and the dryer 220 may perform a paring completion step A15a, A15b for being matched to each other by substantially setting the pairing after recognizing each other through the communication with the server 100 and performing the mutual registration process.

The server 100 may perform a maintaining step A16 for maintaining the paired state by maintaining the matched state between the washing communication module 210b and the drying communication module 220b and the communication device 100.

At least one of the registration information receiving step, the registration information storing step, the pairing step, the notifying step and the pairing completion step may be performed by the washing communication module 210b and the drying communication module 220b. Even unless the power is supplied thereto by the respective main control units 210a, 220a, the washing communication module 210b and the drying communication module 220b may maintain a power-supplied state and communicate with the server 100 consistently.

Accordingly, the washing communication control unit 215b and the drying communication control unit 225b may be configured to completely perform the series of the pairing setting processes including exchanging the setting information through the server 100 by receiving the registration information and so on.

Meanwhile, the second washer 230 may perform the pairing with the washer 210 and the dryer 220 according to the same method. The second washer 230 may be paired to the washer 210 and the dryer 220 simultaneously or paired additionally after the washer 210 and the dryer 220 are paired to each other.

Thus, even when the plurality of the home appliances including the washer 210 and the dryer 220 are spaced a preset distance apart from each other, the paired state between them may be set and maintained by the server 100.

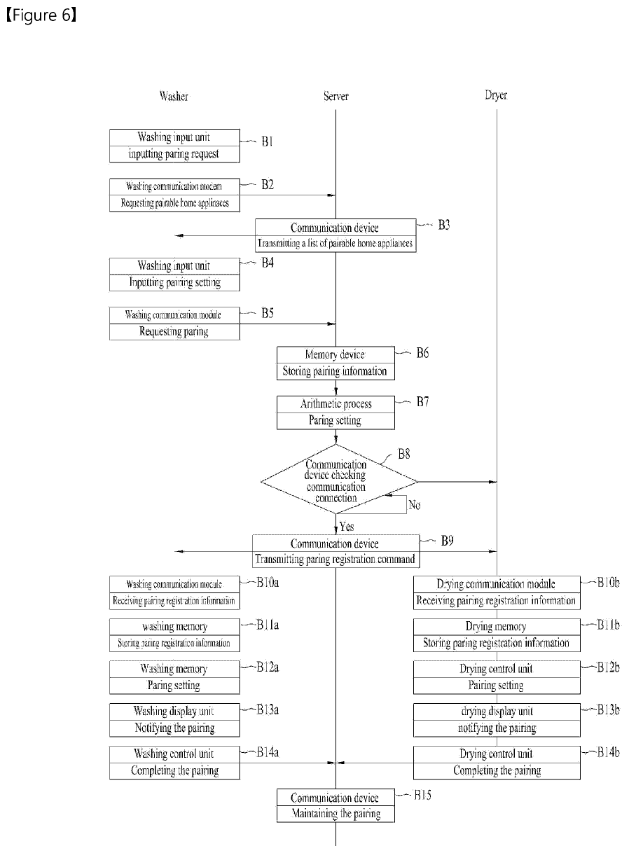

FIG. 6 illustrates another embodiment of a method for pairing the home appliances to each other.

The online system according to the present invention may include a first home appliance 210 having a first communication module configured to communicate with AP 300; a second home appliance 220 having a second communication module configured to communicate with the AP 300; and a server 100 configured to specify and recognize the first and second home appliances based on AP information or port information of the first and second communication modules.

The first home appliance 210 may further include a first input unit 212 configured to receive an input of a command configured to request pairing setting with the second home appliance. When receives the input, the first input unit may transmit a signal to the first communication module to ask the server for the pairing with the second home appliance to the server 100. When receiving the input for requesting the pairing setting from the first communication module 210b, the server 100 may access the second communication module 220b and execute the pairing setting between the first home appliance and the second home appliance.

When the first communication module requests the pairing setting, the server 100 checks a connection state with the second communication module. When the communication with the second communication module is connected, the server may implement the pairing between the first home appliance and the second home appliance. When the communication with the first home appliance is disconnected, the server 100 may standby until the communication is connected or the state information of the second home appliance may be transmitted to the first communication module.

When receiving the input, the first input unit 212 of the first home appliance 210 may transmit a signal for asking the first communication module of the server for a list of second home appliances that can be paired to the first home appliance. When the first communication module receives the list of the second home appliances, the first home appliance may generate setting information configured to perform the pairing with the second home appliance and transmit the generated information to the server.

Hereinafter, referring to FIG. 6, the home appliances include a washer and a dryer. The embodiment shown in FIG. 6 is characterized in that the communication module of the washer 210 or the dryer 220 replaces the externa terminal 400, different from the embodiment shown in FIG. 5.

FIG. 6 illustrates that the washer 210 request the pairing and it is one of the embodiments. Alternatively, the dryer 220 may request the pairing.

Referring to FIG. 6, a request inputting step B1 may be performed for inputting a command for requesting the pairing with one desired home appliance (e.g., the dryer 220) through the washing input unit 212 of the washer 210.

The washing communication module 210b may perform a list requesting step B2 for asking the server for a list of pairable home appliances (a home appliance list). In the list requesting step B2, the server 100 may receive a signal configured to request the home appliance list through the communication device 11 and search the list of the pairable home appliances through the arithmetic processor 12.

Specifically, the server 100 may search the home appliances 200 preregistered or specified by a specific user in the memory device 13 and specify the searched home appliance on the list of pairable home appliances. Alternatively, the server 100 may search home appliances 200 matched to the same user ID or registered in the server 100 via IP of the same AP 300 and specify the searched ones on the list of the pairable home appliances.

The server 100 may perform a list transmitting step B3 for transmitting the list of the pairable home appliances to the washing communication modem 215a through the communication device 11.

Upon receiving the list from the server 100, the washing communication modem 215a may display the pairable home appliances on the washing display unit 211 as icons, letters, images and the like. Accordingly, the user may perform a pairing setting inputting step B4 for inputting one home appliance desired to pair from the list through the washing input unit 212. As one example, the user is able to input an icon of the dryer 220 displayed on the washing display unit 211 and set the pairing.

The washing communication module 210b or the washing control unit 210a may perform a pairing requesting step B5 for asking the server 100 for the pairing execution. Alternatively, the washing communication control unit 215b or the washing load control unit 213 may directly generate setting information and transmit the generated information to the server 100. However, the server 100 may be simply asked for the pairing and entrusted with the generation of the setting information or the registration information and the setting of the pairing.\

When receiving a command configured to request the pairing with a specific home appliance (e.g., the dryer 220) from the washer 210, the server 100 may perform a setting information storing step B6 for storing the pairing setting information in the memory device 12. That is to maintain the setting information until the pairing between the home appliances is completed.

The server 100 may perform a pairing setting step B7 for the server directly setting the pairing between the pairing-requested home appliances based on the setting information processed by the arithmetic processor 12. In the pairing setting step B7, the server 100 may directly generate the setting information used in setting the pairing between the washer 210 and the dryer 220 and the washer 210 and the dryer 220 may transmit a signal to each other after recognizing each other. In other words, the pairing setting step B7 may be the step in which the washer 210 and the dryer 220 that are managed by the server 100 are set to be paired to each other in the server 100.

Upon the completion of the pairing setting step B7, the server 100 may perform a communication connection checking step B8 for checking whether the drying communication module 220b of the dryer 220 is communication-connected.

Unless the dryer 220 is communication-connected in the communication connection checking step B8, the server 100 may notify the washer 210 of the list of home communication-interrupted appliances. Accordingly, the user may be induced to check the state of the dryer 220.

Meanwhile, when checking in the communication connection checking step B8 that the dryer 220 is communication-connected, the server 100 may perform a pairing registration command transmitting step B9 for transmitting the pairing registration command to the dryer 220 through the communication device 11 and enabling the dryer 220 to perform pairing. Also, in the pairing registration command transmitting step B9, the registration information including an executable program executed in the washer 210 and the dryer 220 by the server 100 to substantially realize the pairing set by the server 100. Accordingly. The washer 210 and the dryer 220 may recognize each other through the server 100 and transmit or receive the information.

The washer 210 and the dryer 220 may perform a registration information receiving step B10a, B10b for receiving the registration information from the serve 100 through the washing communication module 210a and the drying communication module 220a. The washer 210 and the dryer 220 may perform the actual pairing by executing the registration information.

Hence, the washer 210 and the dryer 220 may store the registration information in the communication memory unit 215c, 225c provided in the communication module or the main memory 214, 225. Accordingly, a state where the pairing between the washer 210 and the dryer 220 is set may be maintained, until the registration information is deleted or updated.

The washer 210 and the dryer 220 may perform a pairing executing step B12a, B12b for substantially executing the mutual pairing by processing the registration information via the respective communication control units 215a, 225a. In the pairing executing step, the respective control units of the washer 210 and the dryer 220 may substantially recognize each other and transceive information with each other.

The washer 210 and the dryer 220 may perform a notifying step B13a, B13b for notifying that the pairing is set on the respective display units 211 and 221. Accordingly, the user is able to recognize that the pairing set through the external terminal is normally executed.

The washer 210 and the dryer 220 may perform a pairing completion step B14a, B14b for substantially matching the mutual pairing through the mutual registration process after recognizing each other by communication with the server 100.

The server 100 may perform a maintaining step B15 for maintaining the paired state by maintaining a paired state between the communication device 11 and the washing communication module 210b and the drying communication module 220b.\

Accordingly, the user is able to pair the respective communication modules of the washer 210 and the dryer 220 through the communication with the server 100.

At this time, when additional pairing of the second washer is performed, the steps may be repeated. Upon performing the pairing, the pairing between the paired home appliances may be automatically set.

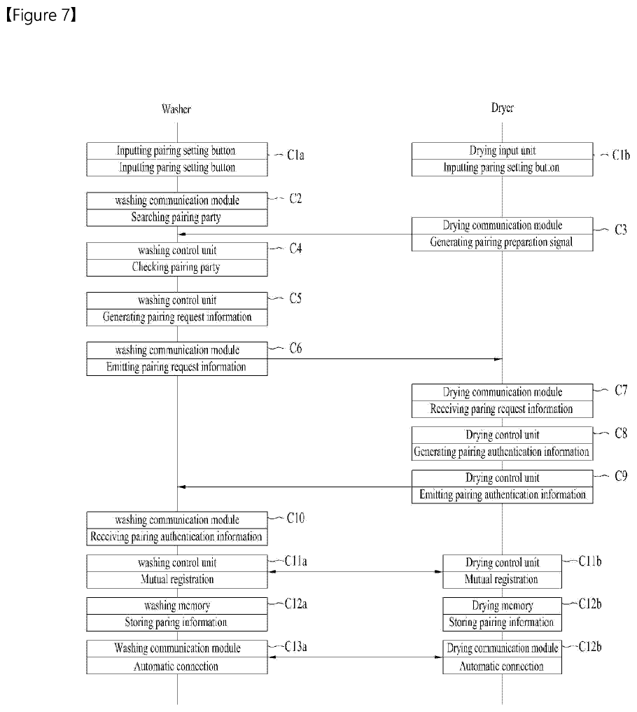

FIG. 7 illustrates one embodiment that the home appliances are directly paired to each other without using the server or the external device.

The online system according to the present invention may include a first home appliance 210 having a first input unit 212 configured to receive a command for requesting the pairing setting and a first control unit 210a configured to generate setting information (e.g., a profile) for executing the pairing setting upon the first input unit receiving the command; and a second home appliance 220 having a second control unit 220b configured to execute the pairing setting with the first home appliance by processing the setting information.

The first home appliance 210 may include a first input unit 211 configured to display or emit light outside by converting the setting information into a specific signal. The second home appliance 220 may further include a second input unit 222 configured to receive the specific signal displayed or emitted on the display unit 222. Upon receiving the specific signal, the second control unit may convert and process the specific signal into the setting information.

The first display unit 211 may include a first liquid crystal 211b configured to display the specific information as a pattern and the second input unit may include a camera 222c configured to photograph and recognize the pattern.

The first display unit 211 may include a first speaker 211a configured to emit the specific signal as a sound signal and the second input unit may include a microphone 222b configured to receive the sound signal.

The second home appliance 220 may further include activation means or a button 222a configured to activate the specific information to receive. The second control unit may sense the reception of the specific information upon receiving the activation means.

Hereinafter, referring to FIG. 7, the home appliance is configured of a washer and a dryer.

The user may perform a washing pairing set button inputting step C1A for transmitting his or her intention to set the pairing by inputting a command to the washer 210 through the washing input unit 212.

Upon completion of the input to the washing input unit 212, the washer 210 may perform a pairable home appliance searching step C2 for searching a pairing-desired home appliance through the washing communication module 210b.

Meanwhile, the dryer 220 may also perform a drying pairing setting button inputting step C1B for transmitting the user's intention to set the pairing by inputting a command to the dryer 220 through the drying input unit 222.

Upon performing the drying pairing setting button inputting step, the dryer 220 may perform a pairing preparation signal generating step C3 for transmitting the setting information necessary to set the pairing through the drying communication module 220b. The dryer 220 may randomly emit the setting information by using the short range communication module, not emitting the setting information to the AP.

The washer 210 may perform a pairable home appliance checking step C4 for recognizing the dryer 220 based on the setting information received via the washing communication module 210b.

Hereinafter, the washer 210 may perform a pairing request information generating step C5 for asking the dryer 220 for the pairing by transmitting requesting information that includes the setting information (e.g., the device ID, the home appliance information, the state information of the washer 210) to the dryer 220 via the washing load control unit 213.

In other words, the washer 210 and the dryer 220 are not set to be paired to each other by receiving a command from the server. The dryer 220 may actively authenticate the pairing or perform the command of the pairing based on the setting information transmitted by the washer 210.

The dryer 220 may perform a pairing request information receiving step C7 for receiving the request information via the drying communication module 210b. The drying communication control unit 225b or the drying load control unit 223 may perform a pairing authentication information generating step C8 for generating authentication information configured to transmit the intention to perform the pairing by specifying the washer 210 based on the request information.

The authentication information may include not only the setting information of the dryer but also a program having a command value used in performing communication with the communication module 220b of the dryer 220 whenever necessary and a code value used in accessing the communication module 220b of the dryer.

The dryer 220 may perform a pairing authentication information transmitting step C9 for transmitting the authentication information via the drying communication module 220b.

The washer may perform a pairing information receiving step C10 for receiving the authentication information via the washing communication module 210b. At this time, the washing communication module 210b may store the authentication information in the washing communication memory 215c.

Hence, the washer 210 may perform a washing mutual registering step C11a for registering the dryer and itself in each other to recognize the dyer and be finally paired to the dryer 220 via the washing communication control unit 216b or the washing load control unit 213.

Also, the dryer 220 may perform a dryer mutual registering step C11b for finally recognizing the washer 210 and being paired to the washer 210 via the drying communication control unit 225b or the drying load control unit 223.

Accordingly, the washing communication module 215b and the drying communication module 225b may be paired to each other so as to recognize each other and access each other to transceive information with each other.

At this time, the washer 210 and the dryer 220 may perform a pairing information storing step C12a, C12b for storing the setting information, the authentication information and the program, that are configured to perform the pairing, in the respective memories. Accordingly, even when the power supplied to the washer 210 and the dryer 220 is cut off and re-supplied, the pairing information may be processed by the respective control units and the pairing may be automatically set without repeating the steps.

In other words, upon performing all of the steps, the washing communication module 210a and the drying communication module 220b may perform an automatic connection step C13a, C13b for automatically searching and recognizing each other to be paired to each other once supplying the power.

FIG. 7 illustrates that the dryer generates and transmits a signal for a pairing preparation signal and pairing authentication information but it is one of embodiments. Alternatively, the washer may generate and transmit the pairing preparation signal and the pairing authentication information, and the dryer may search the pairable home appliance and generate and transmit the pairing request information.

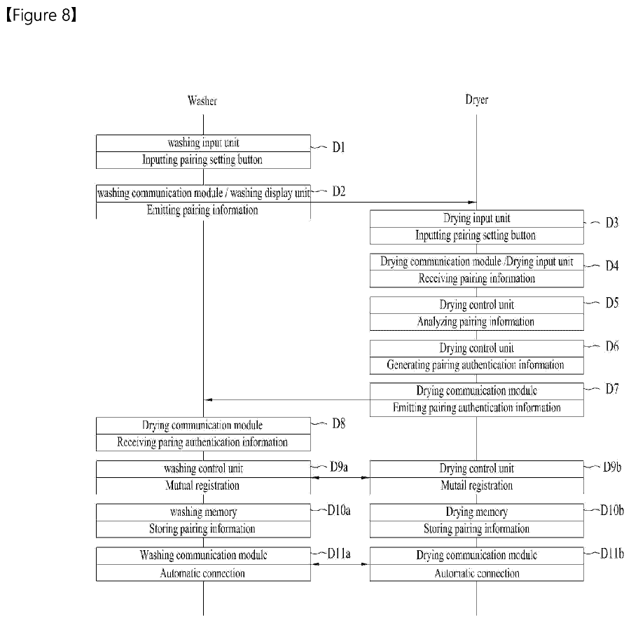

FIG. 8 illustrates a system for directly pairing the home appliances without using the server and the external terminal. The home appliances may include the washer and the dryer.

The washer 210 may perform a pairing setting button input step D1 for receiving the user's input of the intention to set the pairing to the washing input unit 211.

Once performing the inputting step D1, the washer may generate and display the setting information needed in the pairing via the washing communication module 210b or the washing display unit 211 randomly.

The setting information may be converted into a communication signal and emitted to the washing communication module 210b or into a bar code or pattern information and displayed. The setting information may be converted into a sound signal and the sound signal may be emitted to the washing speaker 211a.

The pattern information, the sound signal, the communication signal may be referred to as the specific information. It can be said that the setting information is converted into the specific information to be transmitted, emitted or displayed.

The dryer 220 may perform a pairing information receiving step D4 for photographing the bar code or pattern information as a video image or receiving the sound signal via the drying microphone 222b.

In other words, the dryer 220 may receive the specific information and the setting information based on the specific information.

The pairing information receiving step may be performed when the drying communication module 216b or the drying input unit 222 senses the communication signal, the image signal or the sound signal. The step may be performed when the user performs the drying pairing setting button inputting step D3 for preparing the pairing setting by manipulating the drying input unit 222.

The dryer 220 may perform a pairing information analyzing step D5 for analyzing at least one of the video, sound, communication signals received via the drying camera, the drying microphone or the drying communication module. The drying communication control unit 225b or the drying load control unit 223 of the dryer may determine whether the video signal, the sound signal and the communication signal are converted from the setting information, and then covert the signal into the setting information to process.

The setting information may be analyzed based on the specific information.

The dryer 220 may perform a pairing authentication information generating step D6 for generating authentication information configured to authenticate the pairing with the washer 210 by synthetically checking whether to access the washer, whether it is in connection with the washer 210 and whether the connection with the washer is intended by the user based on the setting information.

Hence, the dryer 2200 may perform a pairing authentication information emitting step D7 for emitting the pairing authentication information via the drying communication module 220b. At this time, the dryer 220 may convert the authentication information into a sound signal and emit the sound signal to the drying speaker or into a video signal and display the video signal on the drying liquid crystal.

The washer 210 may perform a pairing authentication information receiving step D8 for receiving the pairing authentication information via the washing communication module 210b. At this time, the washer 210 may receive the authentication information via the washing microphone or the washing camera.

After that, the washer 210 may perform a mutual registering step D9a for executing the pairing with the dryer 220 by processing the authentication information via the washing communication control unit 216b or the washing load control unit 213 and recognizing the dryer 220 as the pairable party.

At this time, the washer may transmit a signal configured to execute the pairing to the dryer 220. The dryer 220 may also perform a mutual registering step D9b for executing the pairing with the washer 210 by recognizing the washer 210 via the drying communication control unit 225b or the drying load control unit 223.

Accordingly, the washing communication module 215b and the drying communication module 225b may be paired to each other to recognize and access each other and transceive information with each other. At this time, the washer 210 and the dryer 220 may perform a pairing information storing step D10a, D10b for storing the setting information, the authentication information and the program for executing the pairing in the respective memories. Accordingly, even when the power supplied to the washer 210 and the dryer 220 is cut off and resupplied, the pairing information may be processed by the respective control units as it is and the pairing may be automatically performed without repeating the steps.

In other words, upon performing all of the steps, the washing communication module 210a and the drying communication module 220b may perform an automatic connection step D11a, D11b for automatically searching and recognizing each other to be paired to each other once supplying the power.

At this time, the pairing authentication information emitting step and the pairing authentication information receiving step may be performed via the speaker, the microphone, the liquid crystal and the camera.

Accordingly, the washer 210 and the dryer 220 may be paired to each other via the microphone, the speaker, the camera and the liquid crystal, without using the server and the external terminal.

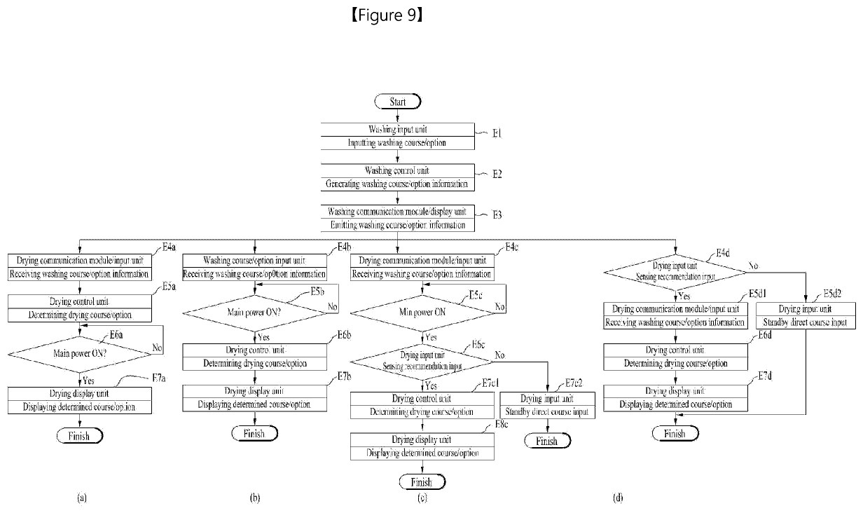

FIG. 9 illustrates one embodiment that uses the washer 210 and the dryer 220 paired to each other.

The embodiment is characterized in that the server 100 is means for setting or maintaining the pairing between the washer 210 and the dryer 220 and that the dryer 220 may receive a washing course and washing options from the washer 210 to determine a corresponding drying course or corresponding drying options directly.

Specifically, one embodiment of the online system according to the present invention may include a washer 210 configured to perform free washing courses performing a wash cycle for removing foreign substances from clothing or washing options; and a dryer 220 configured to perform free drying courses or drying options performing a dry cycle for removing moisture from clothing.

The washer 210 may include a first communication module 210b configured to provide the executed washing course or options to the dryer out of the free washing courses and options. The dryer 220 may include a second communication module 220b configured to receive the washing course or options provided by the first communication module; a control unit 220a configured to determine or transmit corresponding drying course or options to the washing course or options provided by the first communication module out of the free drying courses and options; and a display unit 221 configured to display the drying course or options determined or transmitted by the control unit outside.

The second communication module 220b may include a second communication memory 225c configured to receive and store the washing course or options provided by the first communication module, even in a state where the dryer is paused.

Once receiving the washing course or options from the first communication module, the second communication module 220b may further include a communication control unit 225b configured to determine a corresponding drying course or options to the washing course or options provided by the first communication module and provide the determined drying course or options to the control unit.

Once determining the drying course or options, the control unit may directly transmit the determined drying course or options to the display unit 222.

The dryer 220 may further include an input unit 222 configured to indicate the display unit to display the corresponding drying course or options to the washing course or options provided by the first communication module out of the free drying courses and options. The control unit 220a may transmit the determined drying course or options to the display unit to display, once the user manipulates and inputs a command to the input unit 222.

In addition, the second communication module 220b may ask the first communication module for the executed washing course or washing options and receive the washing course or options.

Specifically, referring to FIG. 9, one embodiment of specific control methods will be described.

The washer 210 and the dryer 220 may directly maintain the paired state and to recognize each other and communicate with each other.

The user may perform a washing course/option input step E1 for performing a free washing course or washing options by manipulating the washing input unit 211 of the washer 210.

The washing load control unit 213 may perform a wash, rinse and dry-spin cycle by executing a corresponding algorithm to the washing course and options input via the washing input unit 211. Meanwhile, the washing control unit 213 may perform a washing information generating step E2 for generating information related with names or characteristics of the washing course and options. In the information generating step E2, information related with the currently performed washing course or options is generated in the dryer 220 or the paired home appliance or the server 100.

As one example, when the washer 210, the server 100 and the dryer 220 are manufactured by the same company, the washing information may be corresponding to proper nouns or names of the washing course and options. However, when they are manufactured by different companies or the washing information is applicable only to the washer 210, the washing information may include characteristics of drum RPM, driving characteristics of the water supply valve and water discharge valve, characteristics of the water temperature and level and the like during the washing course or options.

As one example, when a sanitary course is performed in the washer 210, the washing information related with the washing course and options may be the name of the sanitary source or it may be generated as more specific information showing that a rolling motion is performed relatively longer in the wash cycle and there is a section in which the water temperature is kept 55 degrees or more for 10 minutes, and the rinse cycle is performed two times or more than a standard course.

The washer 210 may perform an emitting step E3 for emit the generated washing information to the server 100 or the drying communication module 220b via the washing communication module 210b or freely emitting it to the washing display unit 211, once the washing information is generated. In case the washing display unit is applied in the emitting step E3, the washing information may be converted into the sound signal and emitted to the washing speaker 211b. The washing information may be converted into an image signal (e.g., a barcode and the like) and the image signal may be displayed on the washing liquid crystal 211b. The sound signal and the image signal may be referred to as the specific information.

Accordingly, the dryer 220 may receive the washing information or the specific information via the drying communication module 220b or the drying input unit 222 including the drying microphone 222b and the camera 222c, and then convert the received information into the washing information.

At this time, upon receiving the washing information, the drying communication control unit 225b or the drying load control unit 223 of the dryer 210 may determine the corresponding drying course and options to the information related with the washing course and option performed in the washer. Also, the drying communication control unit 225b or the drying load control unit 223 may receive the corresponding drying course and options to the washing course and options performed in the washer via the server.

The corresponding free drying course and options to the free washing course and options of the washer may be stored in the drying communication memory 225c or the drying main memory 224 as a table. Accordingly, the drying communication control unit 225b or the drying load control unit 223 may determine the drying course and options equal to the table.

In addition, at least one of the drying communication control unit 225b, the drying load control unit 223 and the server 100 may directly determine the drying course and options to the washing course and options. As one example, when RPM or the water level of the drum is low, it may be determined that the clothes are delicate such that it may be determined to lower the temperature of the hot air and a drying course or options having a short drying time may be determined.

Accordingly, at least one of the drying communication control unit 225b, the drying load control unit 223 and the server 100 may display the determined drying course or options on a screen 222b of the dryer 220 and recommend the drying course or options to the user.

Hereinafter, one embodiment that the dryer 220 receives the washing information and recommend it to the user will be described, referring to FIG. 9 (a) through FIG. 9 (d).

Referring to FIG. 9 (a), the dryer 220 may maintain a state where the power is consistently supplied to the communication module 210a or the input unit 222 even if the actuation of the dryer 220 is paused.

Accordingly, when the washing information is emitted or displayed to the washer 210, the dryer 220 may perform a washing information receiving step E4a for receiving the washing information.

At this time, the communication module 220b of the dryer 220 may perform a determining step E5a for determining a corresponding drying course or options to the washing information via the communication control unit 225b. Simultaneously, the communication module 220b of the dryer may store the washing information in the communication memory 225c upon receiving the washing information.

Hence, the dryer 220 may perform a power supply sensing step E6a for checking whether the power of the drying main control unit 220a is switched on. When the power is supplied to the drying main control unit by the user's pushing the power button of the dryer 220, the communication control unit 225b, the communication control unit 225b may perform a displaying step Ela for immediately the determined drying course or options by directly transmitting the determined drying course and options to the drying main control unit 220a or the drying display unit 221.

Accordingly, the control method shown in FIG. 9 (a) is characterized in that the dryer 220 determines the corresponding drying course and options upon receiving the washing information. When the power is supplied to the main control unit 220a by the user's switching on the dryer, the dryer 220 may display the drying course and options quickly.

In other words, the dryer 220 may receive the washing information when the free washing courses or options are performed in the washer 210 and immediately determine the corresponding drying course or options to the free washing courses or options performed in the washer 210. When the power is supplied to the dryer 220, the dryer may immediately recommend the drying course or options to the user.

After that, the user may perform the determined drying course and options by the user's inputting the operation of the input unit 222. If not satisfied with the recommended drying course or options, the user may determine a free drying course or options by himself or herself by manipulating the input unit 222 of the dryer 220.

FIG. 9 (b) illustrates another embodiment of the control method. The control method shown in FIG. 9 (b) may maintain a state where the power is consistently supplied even the actuation of the dryer 220 is paused.

Accordingly, when the washing information is transmitted, emitted or displayed from the washer 210, the dryer 220 may perform a washing information receiving step E4b for receiving the washing information.

At this time, the communication module 220b of the dryer 220 may store the washing information in the washing communication memory 215c and then perform a power supply sensing step E5b for checking whether the power supplied to the washing main control unit 210a is switched on.

Different from the control method shown in FIG. 9 (a), the communication module 220b may simply store the washing information in the communication memory 225c, not directly determining the corresponding drying course and options to the washing information. Accordingly, too much load may be prevented from being focused on the communication control unit 225b of the communication module 220b.

When the user supplies the power to the dryer 220, the drying main control unit 220a may perform a determining step E6b for determining a corresponding drying course or options to the washing information. In other words, when the power is supplied, the drying main control unit 220a may receive the washing information and determine a corresponding drying course and options based on the washing information.

Hence, the drying main control unit 220a may perform a displaying step E7b for immediately displaying the determined drying course or options on the drying display unit 221.

Accordingly, the dryer 220 may receive the washing information, when the free washing course or options are performed in the washer 210, and determine the corresponding drying course or options as soon as the power is supplied. After that, once the power is supplied to the dryer 220, the user may be recommended the drying course or drying option.

As a result, the inconvenience that the user has to direct input the free drying courses or drying options may be solved.

FIG. 9 (c) illustrates a further embodiment.

Referring to FIG. 9 (c), the dryer 220 may maintain a state where the power is consistently supplied to the communication module 210a or the input unit 222 even if the actuation of the dryer 220 is paused.

Accordingly, when the washing information is transmitted, emitted or displayed from the washer 210, the dryer 220 may perform a washing information receiving step E4c.

Upon receiving the washing information, the communication module 220b of the dryer 220 may store the washing information in the washing communication memory 215c, and perform a power supply sensing step E5c for checking whether the power of the drying main control unit 220a is switched on.

When the dryer is supplied the power, the main control unit 220a of the dryer may perform an input sensing step E6c for sensing whether the user inputs a recommending button to recommend the drying course and options via the input unit 222. Specifically, the recommending button may function as the activation means provided in the input unit 222 to recommend the drying course and options.

When the user inputs the intention to receive the recommendation of the drying course and options via the input unit 222, the drying main control unit 220a may perform a determining step E7C1 for determining a corresponding drying course and options to the washing course and options based on the washing information and a displaying step E8C for displaying the determined drying course and options on the display unit 221.

Meanwhile, once the input sensing step is performed, the dryer may simultaneously perform an input standby step E7C2 for sensing whether the user directly inputs the drying course or options via the input unit 222.

Even if the dryer 220 and the washer 210 are paired to each other, the user's intention to be recommended the corresponding drying course or options to the washer 210 may be reflected. Accordingly, it may be excluded that the drying course or options are recommended on the display unit of the dryer 220 regardless of the user's intention.

FIG. 9 (d) illustrates a still further embodiment of the control method.

Referring to FIG. 9 (d), the dryer 220 may perform an input sensing step E4d for sensing whether an input is sensed on the recommendation button, even when the washer 210 transmits, emits and displays the washing information. Only when the input to the recommendation button has to be sensed in the input sensing step, the washing information receiving step E5ca, the determining step E6c and the displaying step E7c may be performed.

In other words, the dryer 220 may not receive the washing information unless the input to the recommendation button is sensed in the input sensing step. Even when the input is sensed, the dryer may not determine the corresponding drying course or option. Accordingly, the excessive operation of the control unit even without the user's recommendation intention may be prevented and the generation of the unnecessary load may be then removed.

In this instance, the power supply sensing step may be omitted. To sense the presence of the input to the recommendation button, the power supply to the dryer 220 has to be premised.

As a result, only when the user switches on the dryer 220 and inputs the recommendation button actively, the drying options may be recommended to the drying course automatically.

Meanwhile, when performing the input sensing step, the dryer may simultaneously perform a step of sensing input standby step E5d2 for sensing whether the user directly inputs a drying course or a drying option via the input unit 222.

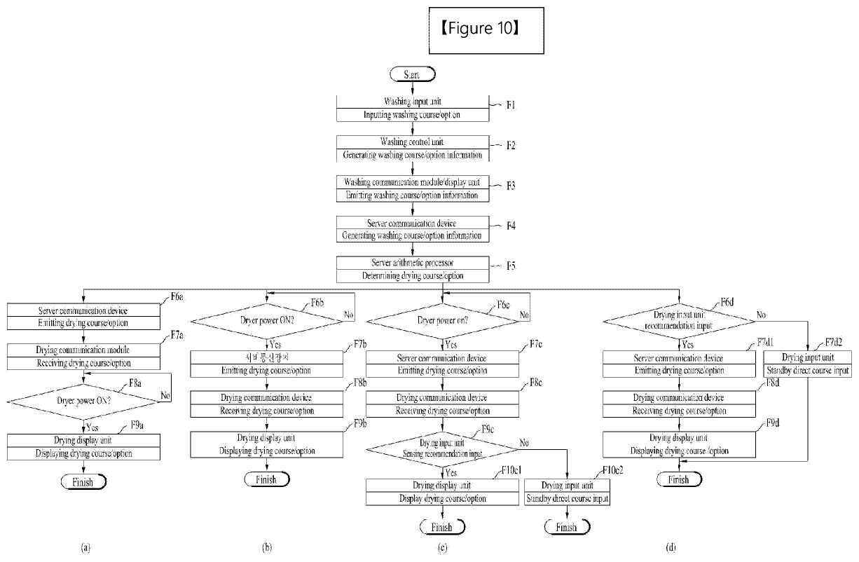

FIG. 10 illustrates one embodiment that uses the pairing set between the washer and the dryer by the server.

The online system according to the present invention may include a washer 210 configured to perform free washing courses or washing options executing a wash cycle configured to remove foreign substances from clothing and including a first communication module 210b configured to transmit the performed washing course and washing option; a server configured to determine a corresponding drying course or drying option to the washing course or washing options by receiving the washing course or washing option transmitted by the first communication module out of free drying courses and drying options; and a dryer 220 configured to execute the drying course and drying option determined by the ser. The dryer may include a second communication module 220b configured to receive the drying course or option determined by the server; and a display unit 222 configured to display the received drying course or option.

The second communication module 220b may communicate with the server even in a state where the actuation of the dryer is paused. The server 100 may transmit the drying course or drying option to the second communication module, once determining the drying course or drying option. Once sensing that the power is supplied to the dryer, the second communication module 220b may ask the server to receive the drying course or drying option.

The dryer 220 may further include an input unit 221 configured to indicate and display the drying course and drying option determined by the server. The display unit 222 may display the drying course or drying option received from the second communication module, when the input to the input unit is sensed.

In addition, the second communication module 220b may ask the server for the drying course and drying option, once the input to the input unit is sensed.

In other words, the online system of FIG. 10 is characterized in that the server directly determine the corresponding drying course and drying option to the received washing information. Accordingly, the drying course and drying option may be transmitted to the dryer simply and the dryer 220 may perform the transmitted course and option. The excessive load applied to the control unit of the dryer may be prevented or no additional high-functioned component (e.g., a parallel arithmetic processor) may be installed, such that the unit price of the dryer can be lowered and the control method of FIG. 10 can be applied to the conventional dryer advantageously.

Specifically, embodiment of the control method shown in FIG. 10 will be described.

The washer and the dryer may be paired to each other to recognize each other and communicate with each other.

The user may perform a washing course/option inputting step F1 for performing a free washing course or a free washing option by inputting a command to the washing input unit 211 of the washer 210.

The washing load control unit 213 may perform a wash, rinse and dry-spin cycle by executing a corresponding algorithm to the washing course and options input via the washing input unit 211. Meanwhile, the washing control unit 213 may perform a washing information generating step F2 for generating information related with names or characteristics of the washing course and options. In the information generating step F2, information related with the currently performed washing course or options is generated in the dryer 220 or the paired home appliance or the server 100.

As one example, when the washer 210, the server 100 and the dryer 220 are manufactured by the same company, the washing information may be corresponding to proper nouns or names of the washing course and options. However, when they are manufactured by different companies or the washing information is applicable only to the washer 210, the washing information may include characteristics of drum RPM, driving characteristics of the water supply valve and water discharge valve, characteristics of the water temperature and level and the like during the washing course or options.

As one example, when a sanitary course is performed in the washer 210, the washing information related with the washing course and options may be the name of the sanitary source or it may be generated as more specific information showing that a rolling motion is performed relatively longer in the wash cycle and there is a section in which the water temperature is kept 55 degrees or more for 10 minutes, and the rinse cycle is performed two times or more than a standard course.

Once the washing information is generated, the washer 210 may perform an emitting step F3 for emitting the generated washing information to the server 100 via the washing communication module 210b.

The server 100 may perform a washing information receiving step F4 for receiving the washing information via the communication device 11 and a determining step F5 for determining a corresponding drying course and drying option to the washing course and washing option performed in the washer 210 by processing the washing information through the arithmetic processor 12.

The corresponding free drying course and options to the free washing course and options of the washer may be stored in the memory device 13 of the server 100 as a table. In addition, the server may directly determine the corresponding drying course and options to the washing course and options. As one example, when RPM or the water level of the drum is low, it may be determined that the clothes are delicate such that it may be determined to lower the temperature of the hot air and a drying course or options having a short drying time may be determined.

Accordingly, the server 100 may display the determined drying course or drying option on the screen 222b of the dryer 220 to recommend it to the user.

Specifically, a control method of displaying the drying course and drying option determined by the server on the display unit 222 of the dryer will be described, referring to FIG. 10 (a) through FIG. 10 (d).

Referring to FIG. 10 (a), the communication device 11 of the server may perform a drying course/option emitting step F6a for emitting the drying course and drying option determined by the arithmetic processor to the dryer 220 paired to the washer 210.

The communication module 220b of the dryer 220 may perform a drying course/option receiving step Fla for receiving the drying course and drying option, even unless the power is supplied to the drying main control unit 220a of the dryer.

The communication module 220b of the dryer may perform a power supply sensing step for checking whether the power is supplied to the main control unit 220a of the dryer and standby until the power is supplied in a state where no power is supplied to the main control unit 220a.

The drying main control unit 220a may perform a displaying step F9a for displaying the drying course and drying option on the display unit 222 by receiving the drying course and drying option from the communication module 220b, once the power is supplied.

Accordingly, the washing course and washing option performed in the washer 210 may be transmitted to the server 100 and the corresponding drying course and drying option may be determined. Once the power is supplied to actuate the dryer 220, the drying course and drying option may be displayed on the display unit 222 to be recommended to the user.

FIG. 10 (b) illustrates another control method different from FIG. 10 (a).

Referring to FIG. 10 (b), the communication module 220b may perform a power supply sensing step F6b for sensing whether the power is supplied to the dryer 220.

Once the power supplied to the dryer is sensed in the power supply sensing step F6b, the communication module 220b of the dryer 220 may transmit state information including the information indicating that the power is supplied to the dryer to the server 100.

The server may perform an emitting step F7b for emitting the drying course and drying option determined by the arithmetic processor to the communication module 220b of the dryer 220, once receiving the state information indicating that the power is supplied to the dryer.

The communication module 220b may perform a receiving step F8b for receiving the drying course or drying option from the server. In the receiving step, the communication module 220b may store the drying course or drying option in the communication memory 225c or transmit it to the main control unit 220a.

The dryer 220 may perform a displaying step F9b for displaying the drying course and drying option stored in the communication memory 225c or transmitted to the main control unit 220a.

Accordingly, communication efficiency may be maximized by transmitting the drying course and drying option through a conventional process of the communication module 220b and the server transceiving.

FIG. 10 (c) illustrates a further control method.

Referring to FIG. 10 (c), the communication module 220b may perform a power supply sensing step F6c for sensing whether the power is supplied to the dryer 220.

Once the power is supplied to the dryer 220 in the power supply sensing step F6b, the communication module 220b of the dryer 220 may transmit the state information including information indicating that the power is supplied to the dryer 220.

The server may perform an emitting step F7c for emitting the drying course and drying option determined by the arithmetic processor to the communication module 220b of the dryer 220, once receiving the state information about that the power is supplied to the dryer.

The communication module 220b may perform a receiving step for receiving the drying course or drying option from the server When the communication module 220b receives the drying course or drying option, the dryer 220 may perform an input sensing step F9c for sensing whether an input to the recommendation button is sensed to recommend the drying course and option via the input unit 222.

When the user inputs the intention to be recommended the drying course and drying option by directly manipulating the input unit 222, the drying main control unit 220a may perform a displaying step F10C1 for displaying the received drying course and drying option on the display unit 221.

Meanwhile, once performing the input sensing step, the dryer may perform an input standby step F10C2 for sensing whether the user directly inputs the drying course or drying option via the input unit 222. When the user directly inputs the drying course and drying option without inputting the intention to be recommended the drying course and drying option to the server 100, the drying main control unit 220a may ignore the recommended drying course and drying option and actuate the dryer according to the drying course and drying option directly input the user.

Accordingly, even when the dryer 220 and the washer 210 are paired to each other, the user's intention to be recommended the corresponding drying course and drying option to the washer 210 may be reflected. The recommendation of the drying course or drying option regardless of the user's intention may be prevented being displayed.

FIG. 10 (d) illustrates a still further control method.

Referring to FIG. 10 (d), even when the drying course and drying option is determined by the server or the power is supplied to the dryer 220, the dryer 220 may perform an input sensing step F5d for sensing whether an input to the recommendation button is sensed.

Once the input to the recommendation button is sensed in the input sensing step, the communication module 220b may perform a server emitting step F7d1 for the server 100 transmitting the drying course and drying option by requesting the server 100.

The communication module 220b may perform a receiving step F8d for receiving the drying course and drying option from the server. The drying main control unit 220b may display the received drying course and drying option on the display unit 221.

Meanwhile, the dryer 220 may perform an input standby step F7d2 for sensing whether the user directly inputs the drying course or drying option via the input unit 222, once the input sensing step is performed. When the user directly inputs the drying course and drying option without inputting the intention to be recommended the drying course and drying option by the server 100, the dryer 220 may omit the step of receiving the drying course and drying option from the server 100.

Accordingly, even when the dryer 220 and the washer 210 are paired to each other, the user's intention to be recommended the corresponding drying course and drying option to the washer may be reflected. Also, the unnecessary transceiving of the data between the server 100 and the dryer 220 may be omitted.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

1. A system comprising:
a first home appliance comprising a first communication module configured to communicate with an access point (AP);
a second home appliance comprising a second communication module configured to communicate with the AP;
a server configured to recognize the first home appliance and the second home appliance based on AP information from the AP or port information of the first communication module and the second communication module; and
an external terminal comprising (i) an input unit configured to receive a command input requesting a pairing setting between the first home appliance and the second home appliance; and (ii) a long range communication module configured to communicate with the server,
wherein the external terminal is configured to receive a list including the first home appliance and second home appliance from the server, based on the command input requesting the pairing setting being received at the input unit, and
wherein the first home appliance and the second home appliance are configured to be paired to each other based on receiving the command input to execute the pairing setting from the server.

2. The system of claim 1, wherein the server is configured to provide the list including the first home appliance and the second home appliance to the external terminal by specifying the first home appliance and the second home appliance that are configured to communicate with the same AP.

3. The system of claim 1, wherein the system is configured, based on completion of the pairing setting, to maintain the pairing between the first home appliance and the second home appliance even when an actuation of the first home appliance or the second home appliance or both is paused.

4. The system of claim 1, wherein the server is configured, based on receiving the command input requesting the pairing setting between the first home appliance and the second home appliance from the external terminal and being connected to both the first communication module and the second communication module, to transmit the command input thereby executing the pairing setting, and
wherein the server is configured, based on at least one of the first communication module and the second communication module being disconnected from the other communication module, to notify the external terminal of the disconnection.

5. A system comprising:
a first home appliance comprising a first communication module configured to communicate with an AP;
a second home appliance comprising a second communication module configured to communicate with the AP; and
a server configured to recognize the first home appliance and the second home appliance based on AP information from the AP or port information of the first communication module and the second communication module,
wherein the first home appliance further comprises,
a first input unit configured, based on a command input being sensed at the first input unit, to receive the command input requesting a pairing setting with the second home appliance, and to transmit the command input requesting the pairing setting with the second home appliance to the first communication module, and
wherein the server is configured, based on the command input requesting the pairing setting being received, to access the second communication module and to execute the pairing setting between the first home appliance and the second home appliance.

6. The system of claim 5, wherein the server is configured, based on receiving the command input requesting the pairing setting between the first home appliance and the second home appliance, to check a connection state with the second communication module and execute the pairing setting between the first home appliance and the second home appliance based on the second communication module being connected to the server, and
wherein the server is configured, based on the connection state with the second communication module being disconnected, to standby until the connection state is connected or to transmit the connection state information of the second home appliance to the first communication module.

7. The system of claim 5, wherein the first home appliance is configured, based on the command input being sensed at the first input unit, to request the server for a list of home appliances that are configured to be paired with the first home appliance, wherein the second home appliance is selected from the list of home appliances, and
to generate a setting information for executing the pairing with the second home appliance and to transmit the generated setting information to the server, wherein the list of home appliances is transmitted to the first communication module.

8. A system comprising:
a first home appliance comprising aa first input unit configured to receive a command input requesting a pairing setting and cii) a first control unit configured to generate a setting information for executing the pairing setting, based on the command input being received at the first input unit; and
a second home appliance comprising a second control unit configured to execute the pairing setting with the first home appliance by processing the setting information,
wherein the first home appliance further comprises,
a first display unit configured to convert the setting information into a specific signal and to display the specific signal, and
wherein the second home appliance further comprises,
a second input unit configured to receive the specific signal displayed on the first display unit, and
wherein the second control unit is configured, based on the second input unit receiving the specific signal, to convert the specific signal into the setting information and process the setting information.

9. The system of claim 8, wherein the first display unit comprises,
a first liquid crystal configured to display the specific signal as a pattern, and
wherein the second input unit comprises,
a camera configured to photograph and recognize the pattern.

10. The system of claim 8, wherein the first display unit comprises,
a first speaker configured to emit the specific signal as a sound signal, and
wherein the second input unit comprises a microphone configured to receive the sound signal.

11. The system of claim 8, wherein the second home appliance further comprises,
activation means configured to activate receiving of the specific signal, wherein
the second control unit is configured, based on the activation means being inputted, to sense the reception of the specific signal.

12. A system comprising:
a washer configured to execute one or more washing courses or options to perform a wash cycle configured to remove foreign substances from clothing; and
a dryer configured to execute one or more drying courses or options to perform a dry cycle configured to remove moisture from the clothing,
wherein the washer comprises:
a first communication module configured to provide an executed washing course or option of the one or more washing courses or options to the dryer, and
wherein the dryer comprises:
a second communication module configured to receive the executed washing course or option provided by the first communication module,
a drying control unit configured to determine a corresponding drying course or option to the executed washing course or option provided by the first communication module from the one or more drying courses and options, and
a drying display unit configured to display the corresponding drying course or option determined by the drying control unit.

13. The system of claim 12, wherein the second communication module is configured to receive and store the executed washing course or option provided by the first communication module, even when the actuation of the dryer is paused.

14. The system of claim 13, wherein the second communication module further comprises a drying communication control unit configured, based on receiving the executed washing option from the first communication module, to determine the corresponding drying course or option to the executed washing course or option provided by the first communication module and to provide the determined corresponding drying course or option to the drying display unit or the drying control unit or both.

15. The system of claim 12, wherein the drying control unit is configured, based on the corresponding drying course or option being determined, to immediately transmit and display the determined corresponding drying course or option.

16. The system of claim 12, wherein the dryer further comprises,
a drying input unit configured to display the corresponding drying course or option to the executed washing course or option provided by the first communication module, and
wherein the drying control unit is configured to transmit the determined corresponding drying course or option to the drying display unit to display it thereon.

17. The system of claim 12, wherein the dryer further comprises,
a drying input unit configured to display the corresponding drying course or option to the executed washing course or option provided by the first communication module, and
wherein the second communication module is configured, based on the input being sensed at the drying input unit, to request and receive the executed washing course or option from the first communication module.

18. A system comprising:
a washer configured to execute one or more washing courses or options to perform a wash cycle configured to remove foreign substances from clothing, wherein the washer comprises a first communication module configured to emit an executed washing course or option;
a server configured to determine a corresponding drying course or option to the executed washing course or option from the one or more drying courses or options to perform a dry cycle configured to remove moisture from clothing by receiving the executed washing course or option emitted by the first communication module; and
a dryer configured to execute the corresponding drying course or option determined by the server,
wherein the dryer comprises aa second communication module configured to receive the executed washing course or option emitted by the first communication module; and cii) a drying display unit configured to display the corresponding drying option determined by the server.

19. The system of claim 18, wherein the second communication module is configured to communicate with the server, even when the actuation of the dryer is paused, and
wherein the server is configured, based on the corresponding drying option being determined, to emit the corresponding drying course or option to the second communication module.

20. The system of claim 18, wherein the second communication module is configured, based on the power supplied to the dryer being sensed, to request the server for the corresponding drying course or option and to receive the corresponding drying course or option.

21. The system of claim 20, wherein the dryer further comprises a drying input unit configured to receive the corresponding drying course or option determined by the server, and
wherein the drying display unit is configured, based on the drying input unit receiving an input, to display the corresponding drying course or option received by the second communication module.

22. The system of claim 18, wherein the dryer further comprises the drying input unit configured to receive the corresponding drying course or option determined by the server, and
wherein the second communication module is configured, based on the drying input unit receiving an input, to request the server for the corresponding drying course or option.
